(19) United States
(12) Patent Application Publication
(10) Pub. No.: US 2025/0379990 A1
(43) Pub. Date: Dec. 11, 2025

(54) METHOD, APPARATUS, AND MEDIUM FOR VISUAL DATA PROCESSING

(71) Applicants: Douyin Vision Co., Ltd., Beijing (CN); Bytedance Inc., Los Angeles, CA (US)

(72) Inventors: Semih Esenlik, Los Angeles, CA (US); Meng Wang, Beijing (CN); Yaojun Wu, Beijing (CN); Zhaobin Zhang, Los Angeles, CA (US); Kai Zhang, Los Angeles, CA (US); Li Zhang, Los Angeles, CA (US)

(21) Appl. No.: 19/301,859

(22) Filed: Aug. 15, 2025

Related U.S. Application Data
(63) Continuation of application No. PCT/CN2024/077146, filed on Feb. 9, 2024.

(30) Foreign Application Priority Data
Feb. 16, 2023 (WO) PCT/CN2023/076451

(51) Int. Cl. H04N 19/192; H04N 19/132; H04N 19/157

(52) U.S. Cl. CPC H04N 19/192; H04N 19/132; H04N 19/157

(57) ABSTRACT

Embodiments of the present disclosure provide a solution for visual data processing. A method for visual data processing is proposed. The method comprises: determining, for a conversion between visual data and a bitstream of the visual data with a neural network (NN)-based model, a mask sample by performing one or more integer operations on at least one probability parameter sample and at least one value, wherein the mask sample is used in a mask and scale process of the NN-based model, the at least one probability parameter sample is associated with a latent representation of the visual data, and each of the at least one probability parameter sample and the at least one value is an integer; and performing the conversion based on the mask sample.

### CROSS REFERENCE TO RELATED APPLICATIONS

This application is a continuation of International Application No. PCT/CN2024/077146, filed on Feb. 9, 2024, which claims the benefit of International Application No. PCT/CN2023/076451, filed on Feb. 16, 2023. The entire contents of these applications are hereby incorporated by reference in their entireties.

### FIELDS

Embodiments of the present disclosure relates generally to visual data processing techniques, and more particularly, to neural network-based visual data coding.

### BACKGROUND

The past decade has witnessed the rapid development of deep learning in a variety of areas, especially in computer vision and image processing. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC). With the performance of neural image compression continually being improved, neural network-based video compression has become an actively developing research area. However, coding quality of neural network-based image/video coding is generally expected to be further improved.

### SUMMARY

Embodiments of the present disclosure provide a solution for visual data processing.

In a first aspect, a method for visual data processing is proposed. The method comprises: determining, for a conversion between visual data and a bitstream of the visual data with a neural network (NN)-based model, a mask sample by performing one or more integer operations on at least one probability parameter sample and at least one value, wherein the mask sample is used in a mask and scale process of the NN-based model, the at least one probability parameter sample is associated with a latent representation of the visual data, and each of the at least one probability parameter sample and the at least one value is an integer; and performing the conversion based on the mask sample.

According to the method in accordance with the first aspect of the present disclosure, the mask sample used in the mask and scale process is obtained based on integer values and one or more integer operations. Thereby, the mask sample itself is ensured to be an integer, and thus it is device independent. Compared with the conventional solution where a floating point number(s) is involved in the determination of the mask sample, the proposed method is advantageously insusceptible to coding errors at this module, and thus the coding quality can be improved.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of visual data which is generated by a method performed by an apparatus for visual data processing. The method comprises: determining a mask sample by performing one or more integer operations on at least one probability parameter sample and at least one value, wherein the mask sample is used in a mask and scale process of an NN-based model, the at least one probability parameter sample is associated with a latent representation of the visual data, and each of the at least one probability parameter sample and the at least one value is an integer; and generating the bitstream based on the mask sample with the NN-based model.

In a fifth aspect, a method for storing a bitstream of visual data is proposed. The method comprises: determining a mask sample by performing one or more integer operations on at least one probability parameter sample and at least one value, wherein the mask sample is used in a mask and scale process of an NN-based model, the at least one probability parameter sample is associated with a latent representation of the visual data, and each of the at least one probability parameter sample and the at least one value is an integer; generating the bitstream based on the mask sample with the NN-based model; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example visual data coding system, in accordance with some embodiments of the present disclosure;

FIG. 2 is a schematic diagram illustrating an example transform coding scheme;

FIG. 3 illustrates example latent representations of an image;

FIG. 4 is a schematic diagram illustrating an example autoencoder implementing a hyperprior model;

FIG. 5 is a schematic diagram illustrating an example combined model configured to jointly optimize a context model along with a hyperprior and the autoencoder;

FIG. 6 illustrates an example encoding process;

FIG. 7 illustrates an example decoding process;

FIG. 8 illustrates an example decoding process according to the present disclosure;

FIG. 9 illustrates an example learning-based image codec architecture;

FIG. 10 illustrates an example synthesis transform for learning based image coding;

FIG. 11 illustrates an example leaky rectified linear unit (ReLu) activation function;

FIG. 12 illustrates an example ReLu activation function;

FIG. 13 illustrates an example implementation of mask and scale process and gain unit;

FIG. 14 illustrates a flowchart of a method for visual data processing in accordance with embodiments of the present disclosure; and

FIG. 15 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

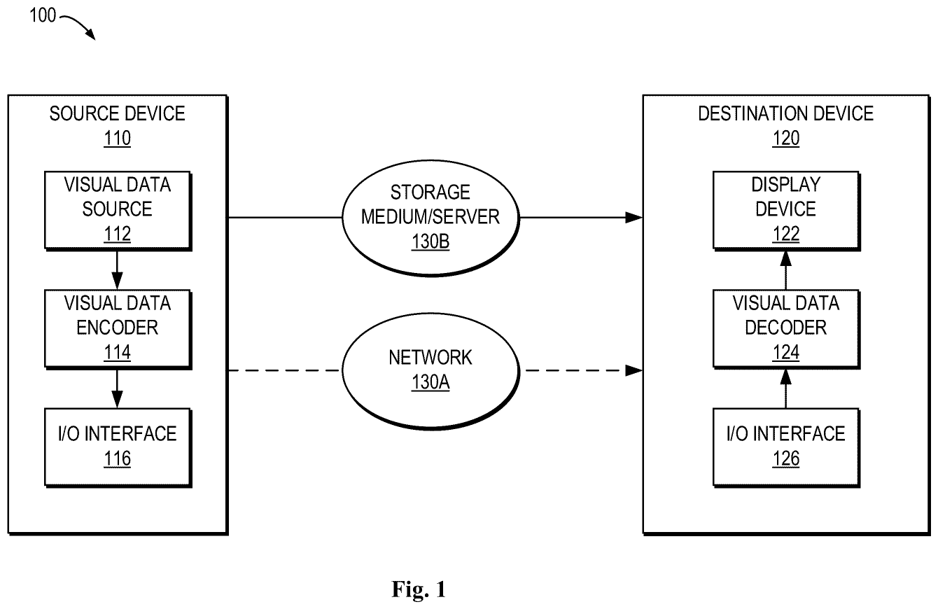

FIG. 1 is a block diagram that illustrates an example visual data coding system 100 that may utilize the techniques of this disclosure. As shown, the visual data coding system 100 may include a source device 110 and a destination device 120. The source device 110 can be also referred to as a visual data encoding device, and the destination device 120 can be also referred to as a visual data decoding device. In operation, the source device 110 can be configured to generate encoded visual data and the destination device 120 can be configured to decode the encoded visual data generated by the source device 110. The source device 110 may include a visual data source 112, a visual data encoder 114, and an input/output (I/O) interface 116.

The visual data source 112 may include a source such as a visual data capture device. Examples of the visual data capture device include, but are not limited to, an interface to receive visual data from a visual data provider, a computer graphics system for generating visual data, and/or a combination thereof.

The visual data may comprise one or more pictures of a video or one or more images. The visual data encoder 114 encodes the visual data from the visual data source 112 to generate a bitstream. The bitstream may include a sequence of bits that form a coded representation of the visual data. The bitstream may include coded pictures and associated visual data. The coded picture is a coded representation of a picture. The associated visual data may include sequence parameter sets, picture parameter sets, and other syntax structures. The I/O interface 116 may include a modulator/demodulator and/or a transmitter. The encoded visual data may be transmitted directly to destination device 120 via the I/O interface 116 through the network 130A. The encoded visual data may also be stored onto a storage medium/server 130B for access by destination device 120.

The destination device 120 may include an I/O interface 126, a visual data decoder 124, and a display device 122. The I/O interface 126 may include a receiver and/or a modem. The I/O interface 126 may acquire encoded visual data from the source device 110 or the storage medium/server 130B. The visual data decoder 124 may decode the encoded visual data. The display device 122 may display the decoded visual data to a user. The display device 122 may be integrated with the destination device 120, or may be external to the destination device 120 which is configured to interface with an external display device.

The visual data encoder 114 and the visual data decoder 124 may operate according to a visual data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific visual data codecs, the disclosed techniques are applicable to other coding technologies also. Furthermore, while some embodiments describe coding steps in detail, it will be understood that corresponding steps decoding that undo the coding will be implemented by a decoder. Furthermore, the term visual data processing encompasses visual data coding or compression, visual data decoding or decompression and visual data transcoding in which visual data are represented from one compressed format into another compressed format or at a different compressed bitrate.

### 1. BRIEF SUMMARY

This disclosure is related to a neural network-based image and video compression approach using separate processing of color components of an image, wherein control parameters used for processing of one component is used also for the other component.

### 2. INTRODUCTION

Deep learning is developing in a variety of areas, such as in computer vision and image processing. Inspired by the successful application of deep learning technology to computer vision areas, neural image/video compression technologies are being studied for application to image/video compression techniques. The neural network is designed based on interdisciplinary research of neuroscience and mathematics. The neural network has shown strong capabilities in the context of non-linear transform and classification. An example neural network-based image compression algorithm achieves comparable R-D performance with Versatile Video Coding (VVC), which is a video coding standard developed by the Joint Video Experts Team (JVET) with experts from motion picture experts group (MPEG) and Video coding experts group (VCEG). Neural network-based video compression is an actively developing research area resulting in continuous improvement of the performance of neural image compression. However, neural network-based video coding is still a largely undeveloped discipline due to the inherent difficulty of the problems addressed by neural networks.

### 2.1 Image/Video Compression

Image/video compression usually refers to a computing technology that compresses video images into binary code to facilitate storage and transmission. The binary codes may or may not support losslessly reconstructing the original image/video. Coding without data loss is known as lossless compression and coding while allowing for targeted loss of data in known as lossy compression, respectively. Most coding systems employ lossy compression since lossless reconstruction is not necessary in most scenarios. Usually the performance of image/video compression algorithms is evaluated based on a resulting compression ratio and reconstruction quality. Compression ratio is directly related to the number of binary codes resulting from compression, with fewer binary codes resulting in better compression. Reconstruction quality is measured by comparing the reconstructed image/video with the original image/video, with greater similarity resulting in better reconstruction quality.

Image/video compression techniques can be divided into video coding methods and neural-network-based video compression methods. Video coding schemes adopt transform-based solutions, in which statistical dependency in latent variables, such as discrete cosine transform (DCT) and wavelet coefficients, is employed to carefully hand-engineer entropy codes to model the dependencies in the quantized regime. Neural network-based video compression can be grouped into neural network-based coding tools and end-to-end neural network-based video compression. The former is embedded into existing video codecs as coding tools and only serves as part of the framework, while the latter is a separate framework developed based on neural networks without depending on video codecs.

A series of video coding standards have been developed to accommodate the increasing demands of visual content transmission. The international organization for standardization (ISO)/International Electrotechnical Commission (IEC) has two expert groups, namely Joint Photographic Experts Group (JPEG) and Moving Picture Experts Group (MPEG). International Telecommunication Union (ITU) telecommunication standardization sector (ITU-T) also has a Video Coding Experts Group (VCEG), which is for standardization of image/video coding technology. The influential video coding standards published by these organizations include Joint Photographic Experts Group (JPEG), JPEG 2000, H.262, H.264/advanced video coding (AVC) and H.265/High Efficiency Video Coding (HEVC). The Joint Video Experts Team (JVET), formed by MPEG and VCEG, developed the Versatile Video Coding (VVC) standard. An average of 50% bitrate reduction is reported by VVC under the same visual quality compared with HEVC.

Neural network-based image/video compression/coding is also under development. Example neural network coding network architectures are relatively shallow, and the performance of such networks is not satisfactory. Neural network-based methods benefit from the abundance of data and the support of powerful computing resources, and are therefore better exploited in a variety of applications. Neural network-based image/video compression has shown promising improvements and is confirmed to be feasible. Nevertheless, this technology is far from mature and a lot of challenges should be addressed.

### 2.2 Neural Networks

Neural networks, also known as artificial neural networks (ANN), are computational models used in machine learning technology. Neural networks are usually composed of multiple processing layers, and each layer is composed of multiple simple but non-linear basic computational units. One benefit of such deep networks is a capacity for processing data with multiple levels of abstraction and converting data into different kinds of representations. Representations created by neural networks are not manually designed. Instead, the deep network including the processing layers is learned from massive data using a general machine learning procedure. Deep learning eliminates the necessity of handcrafted representations. Thus, deep learning is regarded useful especially for processing natively unstructured data, such as acoustic and visual signals. The processing of such data has been a longstanding difficulty in the artificial intelligence field.

### 2.3 Neural Networks for Image Compression

Neural networks for image compression can be classified in two categories, including pixel probability models and auto-encoder models. Pixel probability models employ a predictive coding strategy. Auto-encoder models employ a transform-based solution. Sometimes, these two methods are combined together.

### 2.3.1 Pixel Probability Modeling

According to Shannon's information theory, the optimal method for lossless coding can reach the minimal coding rate, which is denoted as −log₂ p(x) where p(x) is the probability of symbol x. Arithmetic coding is a lossless coding method that is believed to be among the optimal methods. Given a probability distribution p(x), arithmetic coding causes the coding rate to be as close as possible to a theoretical limit-log₂ p(x) without considering the rounding error. Therefore, the remaining problem is to determine the probability, which is very challenging for natural image/video due to the curse of dimensionality. The curse of dimensionality refers to the problem that increasing dimensions causes data sets to become sparse, and hence rapidly increasing amounts of data is needed to effectively analyze and organize data as the number of dimensions increases.

Following the predictive coding strategy, one way to model p(x) is to predict pixel probabilities one by one in a raster scan order based on previous observations, where x is an image, can be expressed as follows:

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, estimation of the conditional probability can be difficult. Thereby, a simplified method is to limit the range of the context of the current pixel as follows:

$$p ( x ) = p ( {x}_{1} ) p ( {x}_{2} \vert {x}_{1} ) … p ( {x}_{i} \vert {x}_{i - k} , … , {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration. For example, when coding the red (R), green (G), and blue (B) (RGB) color component, the R sample is dependent on previously coded pixels (including R, G, and/or B samples), the current G sample may be coded according to previously coded pixels and the current R sample. Further, when coding the current B sample, the previously coded pixels and the current R and G samples may also be taken into consideration.

Neural networks may be designed for computer vision tasks, and may also be effective in regression and classification problems. Therefore, neural networks may be used to estimate the probability of p(xᵢ) given a context x₁,x₂, . . . ,xᵢ₋₁.

Most of the methods directly model the probability distribution in the pixel domain. Some designs also model the probability distribution as conditional based upon explicit or latent representations. Such a model can be expressed as:

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h) indicates the modeling is split into an unconditional model and a conditional model. The additional condition can be image label information or high-level representations.

### 2.3.2 Auto-Encoder

An Auto-encoder is now described. The auto-encoder is trained for dimensionality reduction and include an encoding component and a decoding component. The encoding component converts the high-dimension input signal to low-dimension representations. The low-dimension representations may have reduced spatial size, but a greater number of channels. The decoding component recovers the high-dimension input from the low-dimension representation. The auto-encoder enables automated learning of representations and eliminates the need of hand-crafted features, which is also believed to be one of the most important advantages of neural networks.

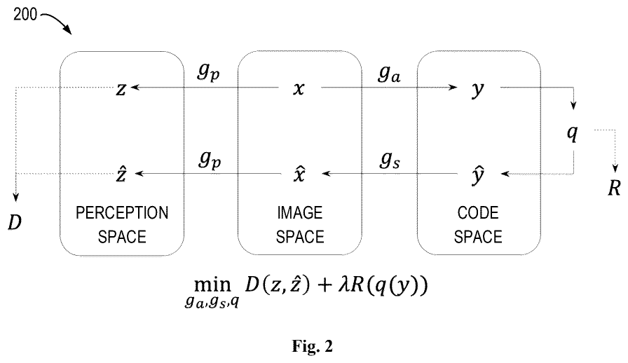

FIG. 2 is a schematic diagram illustrating an example transform coding scheme 200. The original image x is transformed by the analysis network gₐ to achieve the latent representation y. The latent representation y is quantized (q) and compressed into bits. The number of bits R is used to measure the coding rate. The quantized latent representation ŷ is then inversely transformed by a synthesis network gₛ to obtain the reconstructed image \hat{x}. The distortion (D) is calculated in a perceptual space by transforming x and \hat{x} with the function gₚ, resulting in z and \hat{z}, which are compared to obtain D.

An auto-encoder network can be applied to lossy image compression. The learned latent representation can be encoded from the well-trained neural networks. However, adapting the auto-encoder to image compression is not trivial since the original auto-encoder is not optimized for compression, and is thereby not efficient for direct use as a trained auto-encoder. In addition, other major challenges exist. First, the low-dimension representation should be quantized before being encoded. However, the quantization is not differentiable, which is required in backpropagation while training the neural networks. Second, the objective under a compression scenario is different since both the distortion and the rate need to be take into consideration.

Estimating the rate is challenging. Third, a practical image coding scheme should support variable rate, scalability, encoding/decoding speed, and interoperability. In response to these challenges, various schemes are under development.

An example auto-encoder for image compression using the example transform coding scheme 200 can be regarded as a transform coding strategy. The original image x is transformed with the analysis network y=gₐ (x), where y is the latent representation to be quantized and coded. The synthesis network inversely transforms the quantized latent representation ŷ back to obtain the reconstructed image \hat{x}=gₛ(ŷ). The framework is trained with the rate-distortion loss function, [symbol] =D+λR, where D is the distortion between x and \hat{x}, R is the rate calculated or estimated from the quantized representation ŷ, and λ is the Lagrange multiplier. D can be calculated in either pixel domain or perceptual domain. Most example systems follow this prototype and the differences between such systems might only be the network structure or loss function.

### 2.3.3 Hyper Prior Model

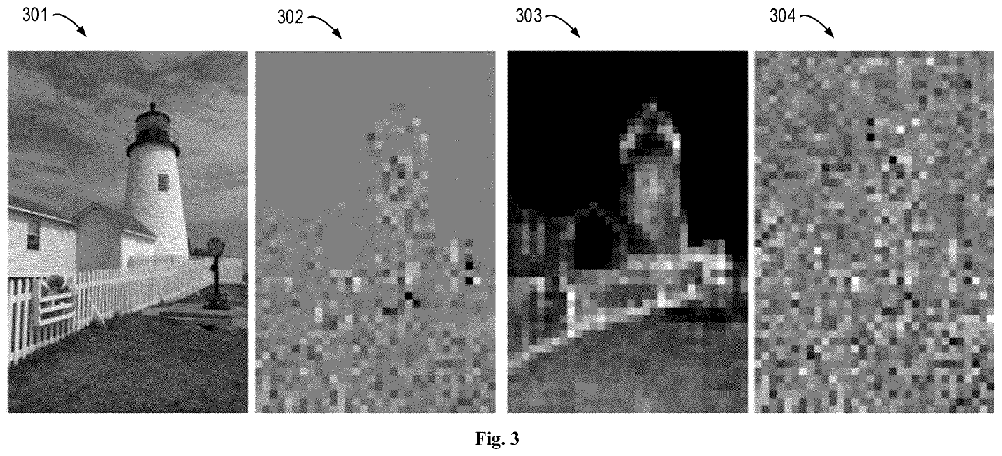

FIG. 3 illustrates example latent representations of an image. FIG. 3 includes an image 301 from the Kodak dataset, va isualization of the latent 302 representation y of the image 301, a standard deviations σ 303 of the latent 302, and latents y 304 after a hyper prior network is introduced. A hyper prior network includes a hyper encoder and decoder. In the transform coding approach to image compression, as shown in FIG. 2, the encoder subnetwork transforms the image vector x using a parametric analysis transform gₐ(x,Ø_{g}) into a latent representation y, which is then quantized to form ŷ. Because ŷ is discrete-valued, ŷ can be losslessly compressed using entropy coding techniques such as arithmetic coding and transmitted as a sequence of bits.

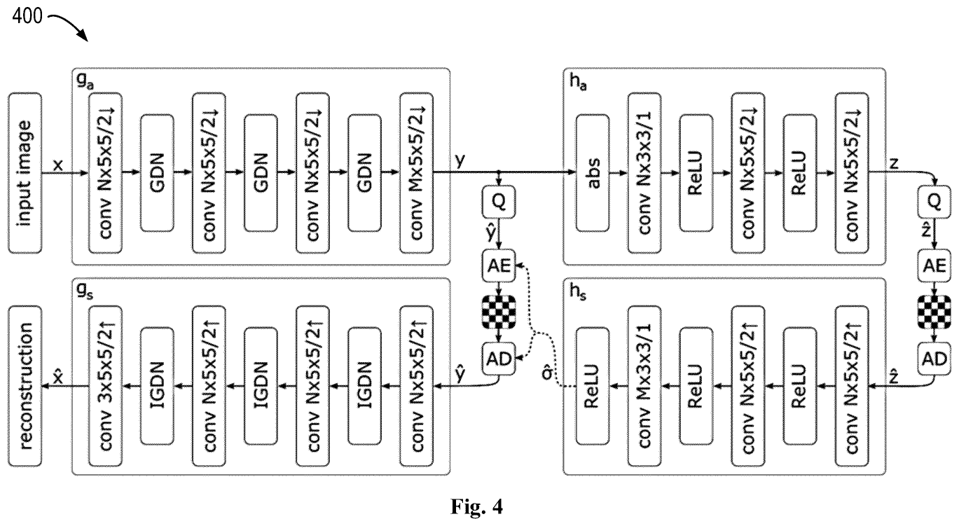

As evident from the latent 302 and the standard deviations σ 303 of FIG. 3, there are significant spatial dependencies among the elements of ŷ. Notably, their scales (standard deviations σ 303) appear to be coupled spatially. An additional set of random variables \hat{z} may be introduced to capture the spatial dependencies and to further reduce the redundancies. In this case the image compression network is depicted in FIG. 4.

FIG. 4 is a schematic diagram 400 illustrating an example network architecture of an autoencoder implementing a hyperprior model. The upper side shows an image autoencoder network, and the lower side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model includes two subnetworks, hyper encoder (denoted with hₐ) and hyper decoder (denoted with hₛ). The hyper prior model generates a quantized hyper latent (\hat{z}) which comprises information related to the probability distribution of the samples of the quantized latent ŷ. \hat{z} is included in the bitstream and transmitted to the receiver (decoder) along with ŷ.

In schematic diagram 400, the upper side of the models is the encoder gₐ and decoder gₛ as discussed above. The lower side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses σ to compress and transmit the quantized image representation ŷ. The decoder first recovers \hat{z} from the compressed signal. The decoder then uses hₛ to obtain σ, which provides the decoder with the correct probability estimates to successfully recover ŷ as well. The decoder then feeds ŷ into gₛ to obtain the reconstructed image.

When the hyper encoder and hyper decoder are added to the image compression network, the spatial redundancies of the quantized latent ŷ are reduced. The latents y 304 in FIG. 3 correspond to the quantized latent when the hyper encoder/decoder are used. Compared to the standard deviations σ 303, the spatial redundancies are significantly reduced as the samples of the quantized latent are less correlated.

### 2.3.4 Context Model

Although the hyper prior model improves the modelling of the probability distribution of the quantized latent ŷ, additional improvement can be obtained by utilizing an autoregressive model that predicts quantized latents from their causal context, which may be known as a context model.

The term auto-regressive indicates that the output of a process is later used as an input to the process.

For example, the context model subnetwork generates one sample of a latent, which is later used as input to obtain the next sample.

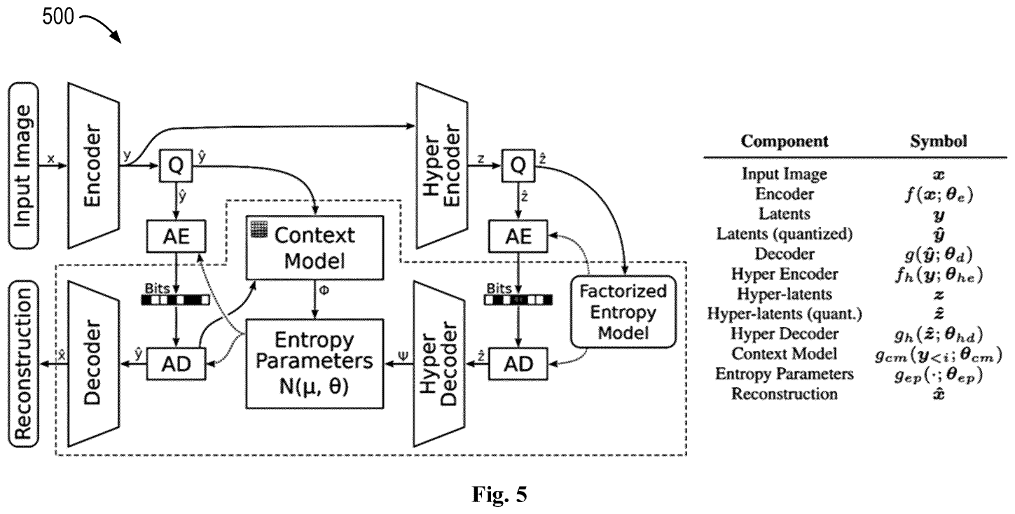

FIG. 5 is a schematic diagram 500 illustrating an example combined model configured to jointly optimize a context model along with a hyperprior and the autoencoder. The combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The dashed region corresponds to the components that are executed by the receiver (e.g, a decoder) to recover an image from a compressed bitstream.

An example system utilizes a joint architecture where both a hyper prior model subnetwork (hyper encoder and hyper decoder) and a context model subnetwork are utilized. The hyper prior and the context model are combined to learn a probabilistic model over quantized latents ŷ, which is then used for entropy coding. As depicted in schematic diagram 500, the outputs of the context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

In an example, the latent samples are modeled as gaussian distribution or gaussian mixture models (not limited to). In the example according to the schematic diagram 500, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5 Gained Variational Autoencoders (G-VAE)

In an example, neural network-based image/video compression methodologies need to train multiple models to adapt to different rates. Gained variational autoencoders (G-VAE) is the variational autoencoder with a pair of gain units, which is designed to achieve continuously variable rate adaptation using a single model. It comprises of a pair of gain units, which are typically inserted to the output of encoder and input of decoder. The output of the encoder is defined as the latent representation y∈R^{c·h·w}, where c, h, w represent the number of channels, the height and width of the latent representation. Each channel of the latent representation is denoted as y₍ᵢ₎ ∈R^{h·W}, where i=0, 1, . . . , c−1. A pair of gain units include a gain matrix M∈R^{c·n} and an inverse gain matrix, where n is the number of gain vectors. The gain vector can be denoted as mₛ={αₛ₍₀₎,αₛ₍₁₎, . . . ,α_{s(c-1)}}, αₛ₍ᵢ₎∈R where s denotes the index of the gain vectors in the gain matrix.

The motivation of gain matrix is similar to the quantization table in JPEG by controlling the quantization loss based on the characteristics of different channels. To apply the gain matrix to the latent representation, each channel is multiplied with the corresponding value in a gain vector.

$${\overline{y}}_{s} = y ⊙ {m}_{s}$$

where ⊙ is channel-wise multiplication, i.e., y̅ₛ₍ᵢ₎=y₍ᵢ₎×αₛ₍ᵢ₎, and as (i) is the i-th gain value in the gain vector mₛ. The inverse gain matrix used at the decoder side can be denoted as M′∈R^{c·n}, which consists of n inverse gain vectors, i.e., M, ={δₛ₍₀₎,δₛ₍₁₎, . . . ,δ_{s(c-1)}}, δₛ₍ᵢ₎ ∈R. The inverse gain process is expressed as:

$${y}_{s}^{′} = \hat{y} ⊙ {m}_{}$$

where ŷ is the decoded quantized latent representation and y [symbol] is the inversely gained quantized latent representation, which will be fed into the synthesis network.

To achieve continuous variable rate adjustment, interpolation is used between vectors. Given two pairs of gain vectors {mₜ,m [symbol] } and {mᵣ,m [symbol] }, the interpolated gain vector can be obtained via the following equations.

$${m}_{v} = [ {( {m}_{r} )}^{l} \cdot {( {m}_{t} )}^{1 - l} ]$$

$${m}_{} = [ {( {m}_{r} )}^{l} \cdot {( {m}_{} )}^{1 - l} ]$$

where l∈R is an interpolation coefficient, which controls the corresponding bit rate of the generated gain vector pair. Since l is a real number, an arbitrary bit rate between the given two gain vector pairs can be achieved.

### 2.3.6 the Encoding Process Using Joint Auto-Regressive Hyper Prior Model

The design in FIG. 5. corresponds an example combined compression method. In this section and the next, the encoding and decoding processes are described separately.

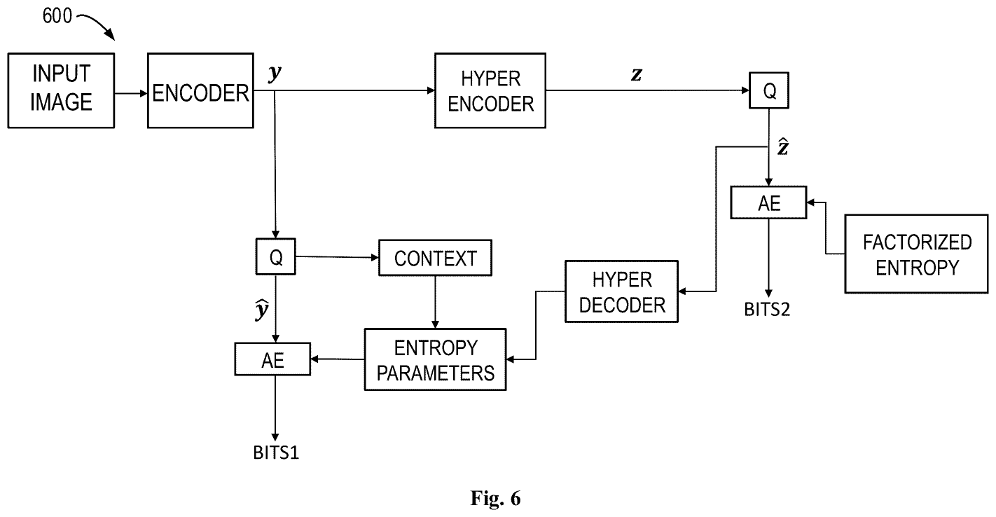

FIG. 6 illustrates an example encoding process 600. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. The entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally, the first and the second bitstream are transmitted to the decoder as result of the encoding process. It is noted that the other names can be used for the modules described above.

In the above description, all of the elements in FIG. 6 are collectively called an encoder. The analysis transform that converts the input image into latent representation is also called an encoder (or auto-encoder).

### 2.3.7 the Decoding Process Using Joint Auto-Regressive Hyper Prior Model

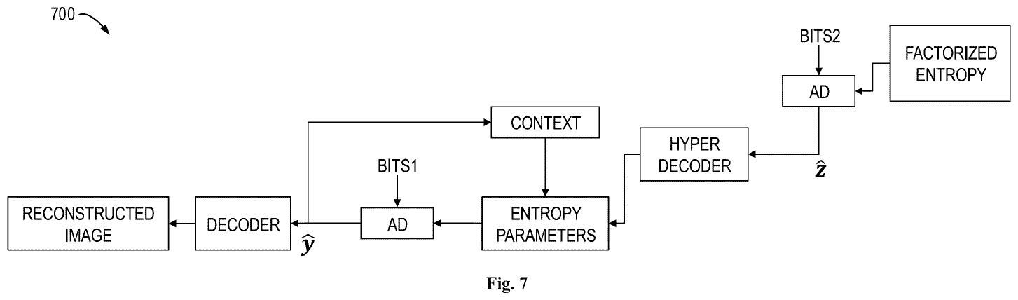

FIG. 7 illustrates an example decoding process 700. FIG. 7 depicts a decoding process separately.

In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore, the exact same probability distributions can be obtained in the decoder (as in encoder), which is essential for reconstructing the quantized latent ŷ without any loss. As a result, the identical version of the quantized latent ŷ that was obtained in the encoder can be obtained in the decoder.

After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization. Finally, the fully reconstructed quantized latent ŷ is input to the synthesis transform (denoted as decoder in FIG. 7) module to obtain the reconstructed image.

In the above description, the all of the elements in FIG. 7 are collectively called decoder. The synthesis transform that converts the quantized latent into reconstructed image is also called a decoder (or auto-decoder).

### 2.4 Neural Networks for Video Compression

Similar to video coding technologies, neural image compression serves as the foundation of intra compression in neural network-based video compression. Thus, development of neural network-based video compression technology is behind development of neural network-based image compression because neural network-based video compression technology is of greater complexity and hence needs far more effort to solve the corresponding challenges. Compared with image compression, video compression needs efficient methods to remove inter-picture redundancy. Inter-picture prediction is then a major step in these example systems. Motion estimation and compensation is widely adopted in video codecs, but is not generally implemented by trained neural networks.

Neural network-based video compression can be divided into two categories according to the targeted scenarios: random access and the low-latency. In random access case, the system allows decoding to be started from any point of the sequence, typically divides the entire sequence into multiple individual segments, and allows each segment to be decoded independently. In a low-latency case, the system aims to reduce decoding time, and thereby temporally previous frames can be used as reference frames to decode subsequent frames.

### 2.5 Preliminaries

Almost all the natural image and/or video is in digital format. A grayscale digital image can be represented by x∈ [symbol] ^{m×n}, where [symbol] is the set of values of a pixel, m is the image height, and n is the image width. For example, [symbol] ={0, 1, 2, . . . , 255} is an example setting, and in this case | [symbol] |=256=2⁸. Thus, the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] ^{m×n×3} with three separate channels storing Red, Green, and Blue information. Similar to the 8-bit grayscale image, an uncompressed 8-bit RGB image has 24 bpp. Digital images/videos can be represented in different color spaces. The neural network-based video compression schemes are mostly developed in RGB color space while the video codecs typically use a YUV color space to represent the video sequences. In YUV color space, an image is decomposed into three channels, namely luma (Y), blue difference choma (Cb) and red difference chroma (Cr). Y is the luminance component and Cb and Cr are the chroma components. The compression benefit to YUV occur because Cb and Cr are typically down sampled to achieve pre-compression since human vision system is less sensitive to chroma components.

A color video sequence is composed of multiple color images, also called frames, to record scenes at different timestamps. For example, in the RGB color space, a color video can be denoted by X={x₀,x₁, . . . ,xₜ, . . . ,x_{T-1}} where T is the number of frames in a video sequence and x∈ [symbol] ^{m×n}. If m=1080, n=1920, | [symbol] |=2⁸, and the video has 50 frames-per-second (fps), then the data rate of this uncompressed video is 1920×1080×8×3×50=2,488,320,000 bits-per-second (bps). This results in about 2.32 gigabits per second (Gbps), which uses a lot storage and should be compressed before transmission over the internet.

Usually the lossless methods can achieve a compression ratio of about 1.5 to 3 for natural images, which is clearly below streaming requirements. Therefore, lossy compression is employed to achieve a better compression ratio, but at the cost of incurred distortion. The distortion can be measured by calculating the average squared difference between the original image and the reconstructed image, for example based on MSE. For a grayscale image, MSE can be calculated with the following equation.

$$M S E = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$PSRN = 10 \times {log}_{10} \frac{{( max ( 𝔻 ) )}^{2}}{MSE} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).

To compare different lossless compression schemes, the compression ratio given the resulting rate, or vice versa, can be compared. However, to compare different lossy compression methods, the comparison has to take into account both the rate and reconstructed quality. For example, this can be accomplished by calculating the relative rates at several different quality levels and then averaging the rates. The average relative rate is known as Bjontegaard's delta-rate (BD-rate). There are other aspects to evaluate image and/or video coding schemes, including encoding/decoding complexity, scalability, robustness, and so on.

### 2.6 Separate Processing of Luma and Chroma Components of an Image

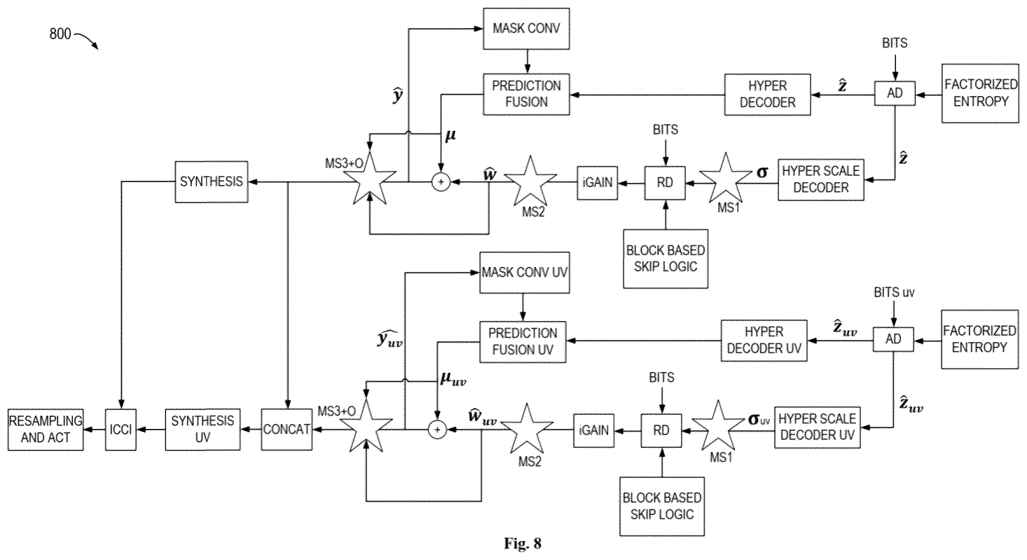

FIG. 8 illustrates an example decoding process 800 according to the present disclosure.

According to one implementation, the luma and chroma components of an image can be decoded using separate subnetworks. In FIG. 8, the luma component of the image is processed by the subnetwoks “Synthesis”, “Prediction fusion”, “Mask Conv”, “Hyper Decoder”, “Hyper scale decoder” etc. Whereas the chroma components are processed by the subnetworks: “Synthesis UV”, “Prediction fusion UV”, “Mask Conv UV”, “Hyper Decoder UV”, “Hyper scale decoder UV” etc.

A benefit of this separate processing is that the computational complexity of the processing of an image is reduced by application of separate processing. Typically, in neural network based image and video decoding, the computational complexity is proportional to the square of the number of feature maps. If the number of total feature maps is equal to 192 for example, computational complexity will be proportional to 192×192. On the other hand if the feature maps are divided into 128 for luma and 64 for chroma (in the case of separate processing), the computational complexity is proportional to 128×128+64×64, which corresponds to a reduction in complexity by 45%. Typically, the separate processing of luma and chroma components of an image does not result in a prohibitive reduction in performance, as the correlation between the luma and chroma components are typically very small.

The processing (Decoding process) in FIG. 8 can be explained below:
1. Firstly, the factorized entropy model is used to decode the quantized latents for luma and chroma, i.e., \hat{z} and \hat{z}ᵤᵥ in FIG. 8.
2. The probability parameters (e.g. variance) generated by the second network are used to generate a quantized residual latent by performing the arithmetic decoding process.
3. The quantized residual latent is inversely gained with the inverse gain unit (iGain) as shown in FIG. 8. The outputs of the inverse gain units are denoted as ŵ and ŵᵤᵥ for luma and chroma components, respectively.
4. For the luma component, the following steps are performed in a loop until all elements of ŷ are obtained:
   a. A first subnetwork is used to estimate a mean value parameter of a quantized latent (ŷ), using the already obtained samples of ŷ.
   b. The quantized residual latent ŵ and the mean value are used to obtain the next element of ŷ.
5. After all of the samples of ŷ are obtained, a synthesis transform can be applied to obtain the reconstructed image.
6. For chroma component, step 4 and 5 are the same but with a separate set of networks.
7. The decoded luma component is used as additional information to obtain the chroma component. Specifically, the Inter Channel Correlation Information filter sub-network (ICCI) is used for chroma component restoration. The luma is fed into the ICCI sub-network as additional information to assist the chroma component decoding.
8. Adaptive color transform (ACT) is performed after the luma and chroma components are reconstructed.

The module named ICCI is a neural-network based postprocessing module. The examples are not limited to the UCCI subnetwork. Any other neural network based postprocessing module might also be used.

An exemplary implementation of the disclosure is depicted in FIG. 8 (the decoding process). The framework comprises two branches for luma and chroma components respectively. In each of the branches, the first subnetwork comprises the context, prediction and optionally the hyper decoder modules. The second network comprises the hyper scale decoder module. The quantized hyper latent are \hat{z} and \hat{z}ᵤᵥ. The arithmetic decoding process generates the quantized residual latents, which are further fed into the iGain units to obtain the gained quantized residual latents ŵ and ŵᵤᵥ.

After the residual latent is obtained, a recursive prediction operation is performed to obtain the latent and ŷᵤᵥ. The following steps describe how to obtain the samples of latent ŷ[:,i,j], and the chroma component is processed in the same way but with different networks.
1. An autoregressive context module is used to generate first input of a prediction module using the samples ŷ[:,m,n] where the (m, n) pair are the indices of the samples of the latent that are already obtained.
2. Optionally the second input of the prediction module is obtained by using a hyper decoder and a quantized hyper latent \hat{z}₁.
3. Using the first input and the second input, the prediction module generates the mean value mean [:,i,j].
4. The mean value mean [:,i,j] and the quantized residual latent ŵ[:,i,j] are added together to obtain the latent ŷ[:,i,j].
5. The steps 1-4 are repeated for the next sample.

Whether to and/or how to apply at least one method disclosed in the document may be signaled from the encoder to the decoder, e.g. in the bitstream.

Whether to and/or how to apply at least one method disclosed in the document may be determined by the decoder based on coding information, such as dimensions, color format, etc.

Further, the modules named MS1, MS2 or MS3+O (in FIG. 8), might be included in the processing flow. The said modules might perform an operation to their input by multiplying the input with a scalar or adding an adding an additive component to the input to obtain the output. The scalar or the additive component that are used by the said modules might be indicated in a bitstream.

The module named RD or the module named AD in FIG. 8 might be an entropy decoding module. It might be a range decoder or an arithmetic decoder or the like.

The examples described herein is not limited to the specific combination of the units exemplified in FIG. 8. Some of the modules might be missing and some of the modules might be displaced in processing order. Also, additional modules might be included. For example:
1. The ICCI module might be removed. In that case the output of the Synthesis module and the Synthesis UV module might be combined by means of another module, that might be based on neural networks.
2. One or more of the modules named MS1, MS2 or MS3+O might be removed. The core of the disclosure is not affected by the removing of one or more of the said scaling and adding modules.

In FIG. 8, other operations that are performed during the processing of the luma and chroma components are also indicated using the star symbol. These processes are denoted as MS1, MS2, MS3+O. These processing might be, but not limited to, adaptive quantization, latent sample scaling, and latent sample offsetting operations. For example, in an adaptive quantization process might correspond to scaling of a sample with multiplier before the prediction process, wherein the multiplier is predefined or whose value is indicated in the bitstream. The latent scaling process might correspond to the process where a sample is scaled with a multiplier after the prediction process, wherein the value of the multiplier is either predefined or indicated in the bitstream. The offsetting operation might correspond to adding an additive element to the sample, again wherein the value of the additive element might be indicated in the bitstream or inferred or predetermined.

Another operation might be tiling operation, wherein samples are first tiled (grouped) into overlapping or non-overlapping regions, wherein each region is processed independently. For example the samples corresponding to the luma component might be divided into tiles with a tile height of 20 samples, whereas the chroma components might be divided into tiles with a tile height of 10 samples for processing.

Another operation might be application of wavefront parallel processing. In wavefront parallel processing, a number of samples might be processed in parallel, and the amount of samples that can be processed in parallel might be indicated by a control parameter. The said control parameter might be indicated in the bitstream, be inferred, or can be predetermined. In the case of separate luma and chroma processing, the number of samples that can be processed in parallel might be different, hence different indicators can be signalled in the bitstream to control the operation of luma and chrome processing separately.

### 2.7 Colors Separation and Conditional Coding

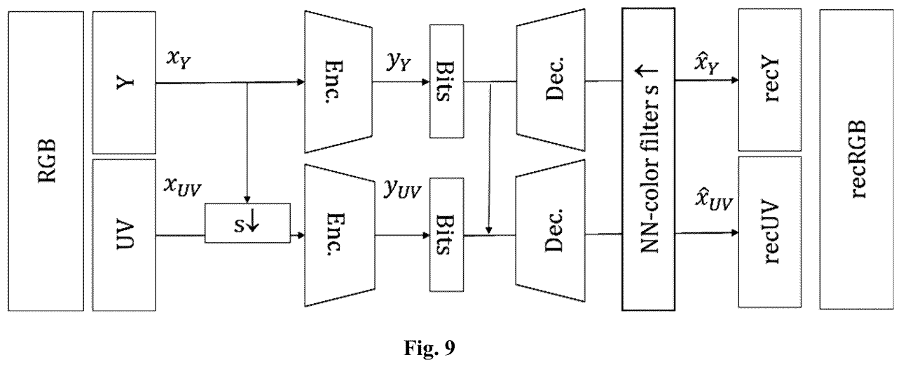

FIG. 9 illustrates an example learning-based image codec architecture.

In one example the primary and secondary color components of an image are coded separately, using networks with similar architecture, but different number of channels as shown in FIG. 9. All boxes with same names are sub-networks with the similar architecture, only input-output tensor size and number of channels are different. Number of channels for primary component is Cₚ=128, for secondary components is Cₛ=64. The vertical arrows (with arrowhead pointing downwards) indicate data flow related to secondary color components coding. Vertical arrows show data exchange between primary and secondary components pipelines.

The input signal to be encoded is notated as x, latent space tensor in bottleneck of variational auto-encoder is y. Subscript “Y” indicates primary component, subscript “UV” is used for concatenated secondary components, there are chroma components.

First the input image that has RGB color format is converted to primary (Y) and secondary components (UV). The primary component x_{Y} is coded independently from secondary components x_{UV} and the coded picture size is equal to input/decoded picture size. The secondary components are coded conditionally, using x_{Y} as auxiliary information from primary component for encoding x_{UV} and using ŷ_{Y} as a latent tensor with auxiliary information from primary component for decoding ŷ_{UV} reconstruction. The codec structure for primary component and secondary components are almost identical except the number of channels, size of the channels and the several entropy models for transforming latent tensor to bitstream, therefore primary and secondary latent tensor will generate two different bitstream based on two different entropy models. Prior to the encoding x_{Y}, x_{UY} goes through a module which adjusts the sample location by down-sampling (marked as “s↓” on FIG. 9), this essentially means that coded picture size for secondary component is different from the coded picture size for primary component. The scaling factor s is variable, but the default scaling factor is s=2. The size of auxiliary input tensor in conditional coding is adjusted in order the encoder receives primary and secondary components tensor with the same picture size. After reconstruction, the secondary component is rescaled to the original picture size with a neural-network based upsampling filter module (“NN-color filter s↑” on FIG. 9), which outputs secondary components up-sampled with factor s.

The example in FIG. 9 exemplifies an image coding system, where the input image is first transformed into primary (Y) and secondary components (UV). The outputs \hat{x}_{Y}, \hat{x}_{UV} are the reconstructed outputs corresponding to the primary and secondary components. At the and of the processing, \hat{x}_{Y}, \hat{x}_{UV} are converted back to RGB color format. Typically the x_{UV} is downsampled (resized) before processing with the encoding and decoding modules (neural networks). For example the size of the x_{UV} might be reduced by a factor of 50% in each of the vertical and horizontal dimensions. Therefore the processing of the secondary component includes approximately 50%×50%=25% less samples, therefore it is computationally less complex.

### 2.8 Cropping Operation in Neural Network Based Coding

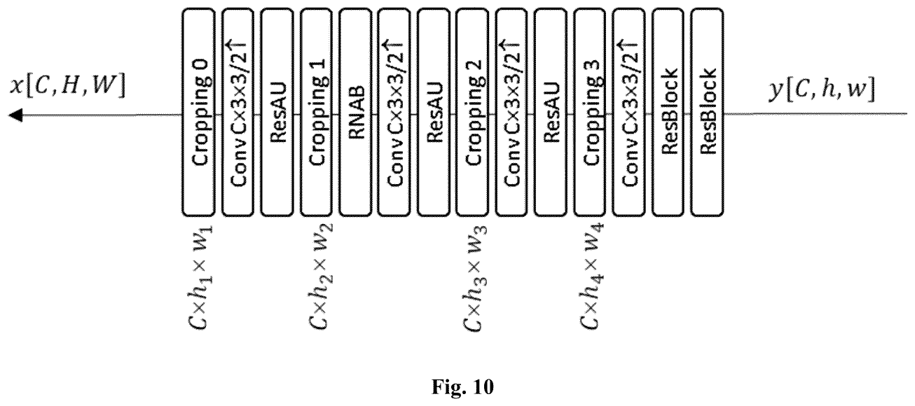

FIG. 10 illustrates an example synthesis transform for learning based image coding.

The example synthesis transform above includes a sequence of 4 convolutions with up-sampling with stride of 2. The synthesis transform sub-Net is depicted on FIG. 10. The size of the tensor in different parts of synthesis transform before cropping layer is the diagram on FIG. 10.

The cropping layer changes tensor size h_{d}×w_{d} to h_{d-1}×w_{d-1}, where h_{d}=2·ceil(H/2^{d}); w_{d}=2·ceil(W/2^{d}); here d is the depth of proceeding convolution in the codec architecture. For primary component Synthesis Transform receives input tensor with sizeh×w; h=ceil(H/16);w=ceil(w/16). The output of Synthesis Transform for primary component is 1×h₀×w₀, where h₀=H;h₀=W.

For secondary component Synthesis Transform receives input tensor with size h_{UV}×w_{UV}; h_{UV}=ceil(ceil(H/s)/16); w_{UV}=ceil(ceil(W/s)/16). The output of the Synthesis Transform for primary component is 2×h_{UV0}×w_{UV0}, where h_{UV0}=ceil(H/s);h_{UV0}=ceil(W/s). For secondary components input sizes are h₀=ceil(H/s);w₀=ceil(W/s), where s is the scale factor. The scale factor might be 2 for example, wherein the secondary component is downsampled by a factor of 2.

Based on the above explanation, the operation of the cropping layers depend on the output size H, W and the depth of the cropping layer. The depth of the left-most cropping layer in FIG. 10 is equal to 0. The output of this cropping layer must be equal to H, W (the output size), if the size of the input of this cropping layer is greater than H or W in horizontal or vertical dimension respectively, cropping needs to be performed in that dimension. The second cropping layer counting from left to right has a depth of 1. The output of the second cropping layer must be equal to h₁=2·ceil(H/2¹); w₁=2·ceil(W/2¹), which means if the input of this second cropping layer is greater than h1, w1 in any dimension, than cropping is applied in that dimension. In summary, the operation of cropping layers are controlled by the output size H,W. In one example if H and W are both equal to 16, then the cropping layers do not perform any cropping. On the other hand if H and W are both equal to 17, then all 4 cropping layers are going to perform cropping.

### 2.9 Bitwise Shifting

The bitwise shift operator can be represented using the function bitshift(x,n), where n is an integer number. If n is greater than 0, it corresponds to right-shift operator (>>), which moves the bits of the input to the right, and the left-shift operator (<<), which moves the bits to the left. In another words the bitshift (x,n) operation corresponds to:

$$bitshift ( x , n ) = x * {2}^{n} , or$$

$$bitshift ( x , n ) = floor ( x * {2}^{n} ) , or$$

$$bitshift ( x , n ) = x // {2}^{n}$$

The output of the bitshift operation is an integer value. In some implementations, the floor ( ) function might be added to the definition.

Floor (x) is equal to the largest integer less than or equal to x.

The “//” operator or the integer division operator: In one example, it is an operation that comprises division and truncation of the result toward zero. For example, 7/4 and −7/−4 are truncated to 1 and −7/4 and 7/−4 are truncated to −1.

$$rightshift ( x , n ) = x ≫ n , or$$

$$leftshift ( x , n ) = x ≪ n$$

### Equation 3: Alternative Implementation of the Bitshift Operator as Rightshift or Leftshift

x>>y Arithmetic right shift of a two's complement integer representation of x by y binary digits. This function is defined only for non-negative integer values of y. Bits shifted into the most significant bits (MSBs) as a result of the right shift have a value equal to the MSB of x prior to the shift operation.
x<<y Arithmetic left shift of a two's complement integer representation of x by y binary digits. This function is defined only for non-negative integer values of y. Bits shifted into the least significant bits (LSBs) as a result of the left shift have a value equal to 0.

### 2.10 Convolution Operation

The convolution operation starts with a kernel, which is a small matrix of weights. This kernel “slides” over the input data, performing an elementwise multiplication with the part of the input it is currently on, and then summing up the results into a single output pixel. In some cases, the convolution operation might comprise a “bias”, which is added to the output of the elementwise multiplication operation.

### 2.11 Clamp Operation

The clamp operation might be defined as: clamp(x,Mx,Mn)=min(max(x,Mn),Mx).

### 2.12 Leaky_Relu Activation Function

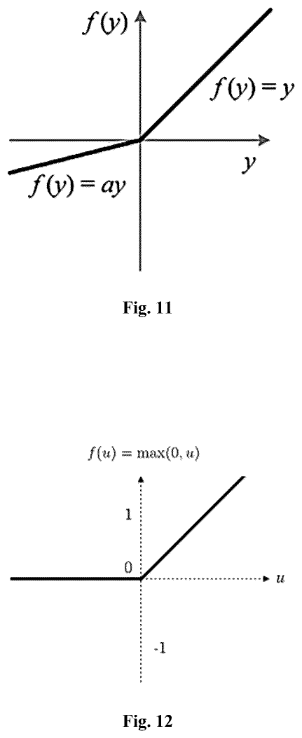

FIG. 11 illustrates an example leaky relu activation function. The leaky_relu activation function is depicted in FIG. 11. According to the function, if the input is a positive value, the output is equal to the input. If the input (y) is a negative value, the output is equal to a*y. The a is typically (not limited to) a value that is smaller than 1 and greater than 0. Since the multiplier a is smaller than 1, it can be implemented either as a multiplication with a non-integer number, or with a division operation. The multiplier a might be called the negative slope of the leaky relu function.

### 2.13 Relu Activation Function

FIG. 12 illustrates an example relu activation function. The relu activation function is depicted in FIG. 12. According to the function, if the input is a positive value, the output is equal to the input. If the input (y) is a negative value, the output is equal to 0.

### 2.14 Extrapolation Gain Unit

In total four models were trained for four different ranges of quality. In JPEG AI learning-based codec, the variable rate capability is achieved by the extrapolation Gain Unit (e.g., a G-Unit and an IG-Unit). The inverse gain unit IG-Unit is working on latent residual tensor after its parsing and de-quantization. To control compression ratio, parameter β is used. The parameter β specifies weight between rate and distortion in loss function during training. The higher β the lower is the distortion due to quantization, but a larger bitstream size is obtained. The Extrapolation Gain Unit is able to work with betas, which value lays outside of range used during model training.

During model training, pairs of reference forward and inverse gain vectors

$$\{ {m}_{t} , {m}_{t}^{- 1} \}$$

are obtained for several β∈{βₜ}. During encoding and decoding those reference gain vectors are known to encoder and decoder (they are part of the models). Gain vectors m and m⁻¹ have dimensions equal to number of channels of the latent space residual tensor r. Inside the Gain Unit, each element of residual tensor r is multiplied by gain factor specified in gain vectors m (all elements of each channel share the same scaling factor). Inside Inverse Gain Unit each element of decoded residual tensor \hat{r} is multiplied by gain factor specified in inverse gain vectors m⁻¹; note that all elements of each channel share the same scaling factor).

With beta parameters from the list used during training β∈{βₜ} only some rates can be obtained. Parameters β∈{βₜ} play similar role as QP in image codecs (such as JPEG, HEVC and VVC). To encode a stream at different rate βv∉{βₜ}, the gain vector is modified, compared to those in dictionary

$$\{ {m}_{t} , {m}_{t}^{- 1} \} .$$

According to the βv gain vector

$${m}_{v} ∉ \{ {m}_{t} , {m}_{t}^{- 1} \}$$

is used to derive anew gain vector mv for βv which is larger than maximum βmax (or smaller than minimum βmin in a {βt} dictionary) the nearest gain vector mₜ and corresponding βt are used:

$${m}_{v} = {m}_{t} * \frac{{β}_{v}}{{β}_{t}} . \qquad ( 6 )$$

To derive a new gain vector mv for βv in between two nearest reference from the dictionary {βₜ}: βₛ<βᵥ<βₘ, linear interpolation is used for getting the power parameter:

$$L = \frac{{β}_{v} - {β}_{s}}{{β}_{m} - {β}_{s}}$$

and finally gain vector is computed as geometric mean of reference gain vectors:

$${m}_{ν} = {m}_{m}^{L} ⊙ {m}_{s}^{1 - L} .$$

Here mₛ and mₘ are corresponding to βₛ and βₘ gain vectors, and L describes ratio between βᵥ, βₛ and βₘ, and ⊙ is element-wise multiplication.

The parameter β is signaled to decoder as 16-bit fixed point number. Similar to QP in other codecs (including in all JPEG AI anchors) β is allowed to be different for primary and secondary components. This information is signaled as high-level syntax element.

### 2.15 Masking and Scaling Operations

The masking and scaling operations are operations that comprise two operations. The first one is generation of a mask. The mask generation process typically takes a probability parameter (e.g. a gaussian variance parameter) as input, and based on the value of the parameter a mask is generated. The mask indicates which samples are going to be processed. The mask generation process might also include a comparison operation with a threshold value, that might be included in the bitstream. For example, if the value of the probability parameter is greater (or smaller) than a threshold, the corresponding mask sample is set equal to 1 (or true), otherwise (if the comparison result is negative), the corresponding mask sample is 0 (or false).

The mask is typically a tensor (or a matrix). If an element of the mask tensor is true (or 1), corresponding residual samples or probability parameter samples or prediction samples are processed. If an element of the mask tensor is false (or 0), corresponding residual samples or probability parameter samples or prediction samples are not processed.

The processing can be:
a scaling operation, e.g. multiplication with a scale factor.
or an inference operation, wherein values of samples are inferred to be equal to zero if the corresponding mask sample is equal to 0.

It is noted that a mask sample value of 1 or 0 (or true or false) are just conventions. In an example implementation the samples corresponding to mask value of 0 might be processed, in another example, the samples corresponding to mask value of 1 might be processed.

### Mask Generation Core Function

The masking generation is a core function which might be used by several coding tools: Residual and Variance Scaling, Latent Scaling Before Synthesis (LSBS) and Skip Mode.

The input of the mask generation core function might be the tensor with sigma samples σ (σ_{Y} and σ_{UV} in primary and secondary components coding pipelines) of size C×h×w. The output might be a mask to be used by one or more of the aforementioned coding tools (those that are enabled). To generate the mask, some syntax elements are used (that might be predefined or signalled), namely Threshold, Greater Flag, Mode and BlockSize.

If the BlockSize is greater than 1, a pooling operation might be applied to the input sigma samples tensor first. Based on the value of the Mode syntax element, the pooling operation might be a max pooling operation, an average pooling or min pooling operation, with a kernel size equal to BlockSize in horizontal or vertical dimension.

The output might be the pooled sigma tensor σₚ with size

$$C \times ceil ( \frac{h}{B lockSize} ) \times ceil ( \frac{w}{B lockSize} ) .$$

If the BlockSize is equal to 1, the size of the pooled sigma samples tensor size might be equal to size of the sigma values tensor C×h×w.

Afterwards each one of the pooled (or original) sigma samples might be compared with the Threshold,. The pooled mask samples might be obtained according to the following:

$$For c = c = 0 … C - 1 , i = 0 … ceil ( \frac{h}{B lockSize} ) - 1 and$$

$$j = 0 … ceil ( \frac{w}{B l o ckSize} ) - 1$$

$${mask}_{p} [ c , i , j ] = \{ \begin{matrix}True if {σ}_{p} [ c , i , j ] > Threshold ⋂ GreaterFlag == True \\ True if {σ}_{p} [ c , i , j ] < Threshold ⋂ Greater == False \\ False Otherwise\end{matrix}$$

After the pooled mask samples tensor maskₚ is obtained, and if the BlockSize is greater than 1, an up-sampling operation might be applied to maskₚ to obtain the final mask samples tensor. The up-sampling operation might be based on nearest neighbor. If the BlockSize is equal to 1, the up-sampling operation might skipped. If the BlockSize is greater than 1, a cropping operation is applied after up-sampling resulting in an output mask tensor with size C×h×w.

It is noted that the core of the masking process is the comparison operation with a threshold value. The aforementioned syntax element names are presented just as examples.

### Example Residual and Variance Scaling (RVS)

The objective of this module is to scale the residual and the variance samples (gaussian parameter samples). Variance scaling is located after Hyper Scale Decoder. The process of RVS achieves adaptive quantization of residual samples based on their corresponding variance value.

Residual and Variance Scaling (RVS) might use six syntax elements. Threshold, Greater Flag, Mode and BlockSize might be used to generate the mask. The fifth and sixth syntax elements are the scale factor Scale and numRVSparams which indicates the number of mask and scale parameter sets to be utilized. If for example numRVSparams is equal to 2, two sets of syntax elements (including Threshold, Greater Flag, Mode, BlockSize and Scale) are signaled. This makes it possible to group the residual and variance samples into two groups (with the help of two different masks), and scaling each group with a different scale parameter (Scale).

An example process of RVS at the decoder might be as follows:
First the scale_hat_modified and residual_hat_modified tensors are initialized to be equal to variance tensor σ and quantized residual tensor \hat{r} respectively.
For idx=0 . . . numRVSparams−1 the following ordered steps are applied:
   A 3D tensor mask[idx] is generated using the mask generation core function (section 3.2.1) with Threshold[idx], GreaterFlag[idx], Mode[idx], BlockSize[idx] and sigma samples tensor as inputs and mask[idx] as output.
   Each sample of the modified residual tensor and modified sigma tensor are obtained as follows:
      If the value of mask[idx][c][h][w] is equal to True residual_hat_modified [c][h][w] is set equal to residual_hat_modified [c][h][w] *Scale[idx].
      If the value of mask[idx][c][h][w] is equal to True scale_hat_modified [c][h][w] is set equal to scale_hat_modified [c][h][w] *Scale[idx].

The modified sigma tensor σ is set equal to scale_hat_modified, and modified quantized residual \hat{r} is set equal to residual_hat_modified tensor. The output of this process is the modified sigma σ and modified quantized residual \hat{r}.

### Example Latent Scaling Before Synthesis (LSBS)

The LSBS process uses seven syntax elements: Scale1, Scale2, Threshold, GreaterFlag, Mode, BlockSize and numLSBSparams. The Scale1, Scale2 are scale factors. The four syntax elements Threshold, Greater Flag, Mode and BlockSize are used to determine the mask as described in section 3.2.1. The seventh syntax element numLSBSparams indicates the number of LSBS parameter sets to be utilized. If for example numRVSparams is equal to 2, two sets of syntax elements (each set including Scale1, Scale2, Threshold, Greater Flag, Mode and BlockSize) are signaled. In this cased LSBS process is applied two times consecutively, in each time a different mask is generated and different scaling factors are applied.

At the decoder, the input of the LSBS process are the residual tensor after entropy decoding \hat{r}, the prediction tensor μ after the prediction fusion process, latent tensor ŷ, and binary mask generated using variance σ as described in section 3.2.1. The process of LSBS at the decoder is as follows:
The y_hat_modified, residual_hat and mean_hat tensors are initialized to be equal to latent samples tensor, residual tensor \hat{r} and prediction tensor μ respectively.
For idx=0 . . . numLSBSparams−1 the following steps are applied:
   A 3D mask tensor mask[idx] is generated using the Mask generation core function with Threshold[idx], GreaterFlag[idx], Mode[idx], BlockSize[idx] and sigma samples tensor as inputs and mask[idx] as output.
   Each sample of the modified latent samples tensor is obtained as follows:
      If mask[idx][c][h][w] is equal to True, then y_hat_modified [c][h][w] is set equal to y_hat_modified [c][h][w]+mean_hat [c][h][w]*Scale2 [idx]+residual_hat [c][h][w] *Scale1[idx].

Modified latent tensor ŷ is set equal to y_hat_modified. The output of this process is the modified latent tensor ŷ.

### Example Residual Skip Mode

The residual skip process uses five syntax elements. The first four syntax elements Threshold, Greater Flag, Mode and BlockSize are used to define the mask. The fifth syntax element numSkipparams indicates the number of residual skip mode parameter sets to be used.

At the decoder, the inputs of skip mode process are the 1D residual array residual_one_dim after the entropy decoding process, and the variance tensor σ after the hyper scale decoding process.

The output of the lossless decoding process is a 1D array residual_one_dim, whose size is equal to the total number of “1”s in the maskAggregate tensor. In other words, the maskAggregate tensor determines which samples of the residual tensor \hat{r} are included in the bitstream. All of the other samples of the quantized residual tensor are inferred to be equal to zero. The process of residual skip mode at the decoder is as follows:
The residual_hat and maskAggregate tensors are initialized to be equal to all zeros and all ones respectively.
The counter k=0.
Dimensions [C,h,w] are set equal to number of channels, height and width of the sigma tensor σ.
For idx=0 . . . numSkipparams−1 the following ordered steps are applied:
   A 3D mask tensor mask[idx] is generated by invoking the mask generation core function with Threshold[idx], GreaterFlag[idx], Mode[idx], BlockSize[idx] and sigma samples tensor as inputs and mask[idx] as output.
   For each element of the mask[idx], maskAggregate[c,i,j] is set equal to maskAggregate[c,i,j] *mask[idx][c,i,j].
   For c=0 . . . . C−1,i=0, . . . ,h−1; j=0, . . . w−1:
      if maskAggregate[c,i,j] is equal to 1 then î[c,i,j] is equal to residual_one_dim [k].
      k is incremented by 1.

The output of this process is the residual tensor î.

### 2.16 Example Implementation of Gain Unit and Mask and Scale Operations

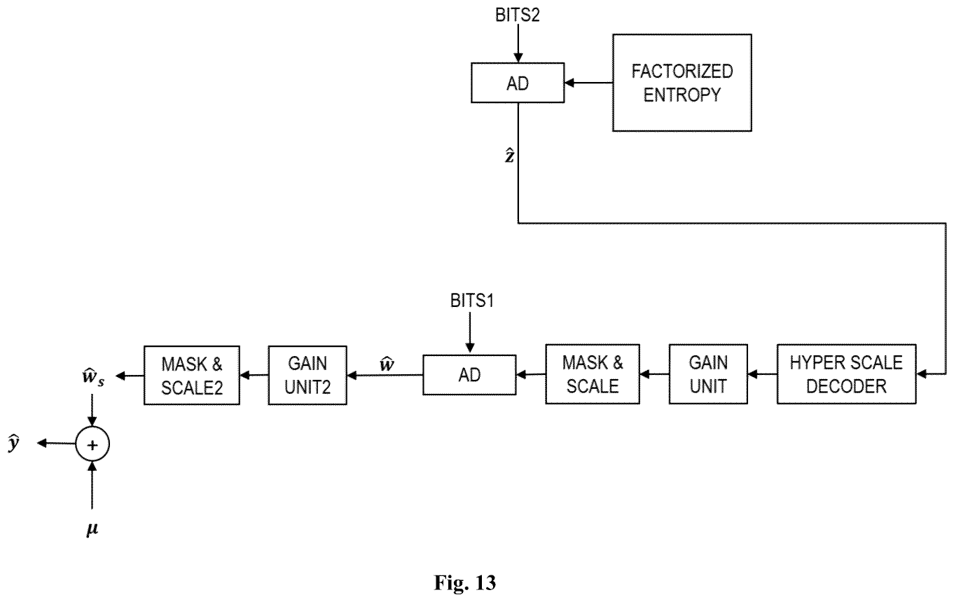

FIG. 13 illustrates an example implementation of mask and scale process and gain unit. An example implementation of the gain unit and the mask and scale process might be according to the FIG. 13. According to the example a first bitstream (or substream) might be used to obtain hyper parameters \hat{z}. The hyper parameters can then be processed with a neural subnetwork (e.g. hyper scale decoder) to obtain probability parameters. The probability parameters might be gaussian scale (e.g. sigma parameters) parameters or mean parameters. The output of the neural subnetwork might then be processed with a gain unit and or a mask and scale process. The output of the said process is then used as input to an entropy decoding process to obtain latent samples (e.g. residual latent samples) or residual samples (denoted ŵ in the FIG. 13). Afterwards the ŵ might be further processed with gain unit process or mask and scale process. Finally, the samples that are output of the second gain unit or mask and scale process might be added to a prediction samples μ to obtain latent samples ŷ. The latent samples are finally processed with a neural subnetwork (e.g. a synthesis transform subnetwork) to obtain the reconstructed picture.

### 3. TECHNICAL PROBLEMS SOLVED BY DISCLOSED TECHNICAL SOLUTIONS

In an image or video compression system, typically an arithmeric coding or other forms of entropy coding methods are employed to convert symbols to string of bits. The process of converting the symbols into bits is a sequential process, which means a small error (e.g. a single bit interpreted as “0” instead of “1”) could cause the whole bitstream to be corrupted, rendering the decoding of the image impossible.

The layers that are used in example neural network implementations comprise operations that include:
Multiplication with floating point number,
Division operation,
Addition with a floating point number,
Rounding operation.
etc.

Such operations are not well defined, and hence the output value might be different from device to device. This small difference might be negligible for most of the applications, however in the case of image and video compression, the small difference can cause a bitstream to be undecodable. The reason is, a single error in decoding of a single bit will impact the interpretation of all of the following bits, corrupting the whole bitstream.

As a result a neural network based image or video coding system is susceptible to decoding errors. A bitstream encoded in one device might not be decodable in another device.

### 4. A LISTING OF SOLUTIONS AND EMBODIMENTS

According to the disclosure a novel masking and scaling operation is devised. The masking and scaling operation is implementable in a device agnostic manner. More specifically any operation that are not well defined (i.e. not friendly for hardware implementation) are not used.

### 4.1 Central Examples

### Decoding Process According to the Disclosure:

According to an example, a bitstream is converted to a reconstructed image (or video) based on a masking and scaling operation, wherein:
A probability parameter sample is obtained using a first neural network.
A first value (e.g. a threshold) is obtained from a bitstream.
based on the first value and the probability parameter sample, obtaining a mask sample.
Processing a second sample based on the value of the mask sample.
Reconstructed image is obtained according to processed second sample.

### Encoding Process According to the Disclosure:

According to an example, an image or video is converted to bitstream based on a gain unit operation, wherein:
A probability parameter sample is obtained using a first neural network.
based on a first value (e.g. threshold) and the probability parameter sample, obtaining a mask sample.
Processing a second sample based on the value of the mask sample.
bitstream is obtained according to processed second sample.
Including an indication pertaining to the first value in the bitstream.

### 4.2 Details of the Examples

Details of the probability parameter sample:
   In an example the probability parameter sample is a gaussian variance sample or a sigma sample.
   The probability parameter sample might be an element of a 3-dimensional tensor or a matrix, whose dimensions might be C×H×W, wherein C, H and W are positive integers.
   The probability parameter sample might be used in an entropy coding process e.g. arithmetic coding or range coding or like.
Obtaining of a mask might comprise any of the following operations:
   Clamping the probability samples according to a min and max values.
      The min and max values might be predefined.
      The min and max values might be derived based on an indication in the bitstream.
   Summing probability parameter samples within a block of size 2ⁿ×2ⁿ, wherein n is a non-negative integer to obtain s (the sum value).
   Performing the following comparison operation to obtain a mask sample:
      First value<(s>>2n), or
      First value≤(s>>2n), or
      First value> (s>>2n), or
      First value≥ (s>>2n), or
      First value< ((s+2²ⁿ⁻¹)>>2n), or
      First value≤((s+2²ⁿ⁻¹)>>2n), or
      First value> ((s+2²ⁿ⁻¹)>>2n), or
      First value≥ ((s+2²ⁿ⁻¹)>>2n).
   The value n might be indicated in the bitstream.
Obtaining of a mask might comprise any of the following steps:
   Clamping the probability samples according to a min and max values.
      The min and max values might be predefined.
      The min and max values might derived based on an indication in the bitstream.
   Summing probability parameter samples within a block of size n×n, wherein n is a non-negative integer to obtain s (sum value).
   Performing the following comparison operation to obtain a mask sample:
      First value< (s//n²), or
      First value≤(s//n²), or
      First value> (s//n²), or
      First value≥ (s//n²), or
      First value< ((s+n²//2)//n²), or
      First value≤((s+n²//2)//n²), or
      First value> ((s+n²//2)//n²), or
      First value≥ ((s+n²//2)//n²).
   The value of the mask sample might be 0 or 1 depending on the aforementioned comparison operation.
   The n might be indicated in the bitstream.
Details of the first value:
   The first value might be an integer value.
   The first value might comprise two components and might be obtained according to first value=a<<b, wherein a and b are integer values that are indicated in the bitstream.
   The first value might comprise two components and might be obtained according to first value=a>>b, wherein a and b are integer values that are indicated in the bitstream.
   The second component of the first value b might be predefined.
   The value of b might have two possibilities. One value or a second value might be selected based on a flag indicated in the bitstream. For example the b might be either 7 or 12, based on an indication in the bitstream, the value of b is assigned to be either 7 or 12. (the values 7 and 12 are provided as example, any non-negative integer values are possible).
   When the first value is composed of 2 components as a and b, the comparison (as exemplified above) with the first value might be performed as follows:
      a< (T<<K), wherein.
         a is the first component of the first value, and
         T is obtained according to summing probability parameter samples within a block of size n×n,
         K is obtained according to b.
         The smaller than (<) operator might be replaced with any other comparison operator.
      (a<<K)<T, wherein
   a is the first component of the first value, and
   T is obtained according to summing probability parameter samples within a block of size n×n,
   K is obtained according to b.
   The smaller than (<) operator might be replaced with any other comparison operator.
Details of processing a second sample based on the value of the mask sample.
   The second sample might be probability parameter sample, e.g. a gaussian variance sample or a sigma sample.
   The second sample might be a residual sample.
   The second sample might be a prediction sample or a sample of a latent representation.
   The processing might comprise inferring the value of the second sample equal to zero. In one example if the value of the mask sample is equal to 0, the value of the second sample is inferred to be equal to zero. If the value of the mask sample is equal to 1, the value of the second sample is obtained from a bitstream.
   In one example the processing might comprise multiplying the second sample with a second value (e.g. a scale).
      The second value might be included a bitstream.
      The second value might be an integer.
      The second value might comprise a nominator (nom) and a denominator (denom). the multiplication might be performed as:
      Second sample*nom/denom
      Second sample*nom//denom
      (Second sample*nom+denom//2)//denom
      Nom or denom might be indicated in the bitstream.
      The denom might be predefined.
   The second value might comprise a first part (a) and a second part (b). the multiplication might be performed as:
      Second sample*a>>b
      Second sample*a<<b
      (Second sample*a+2^{b-1})>>b
      a and/or b might be indicated in the bitstream.
      The b might be predefined.
   The second value might comprise a first part (a) and a second part (b). the multiplication might be performed as:
      Second sample<<b//a
      Second sample*a<<b
      (Second sample<<b+a//2)//a
      a and/or b might be indicated in the bitstream.
      The b might be predefined.
      Wherein “//” is the integer division operator.
   In one example the processing might be Residual and Variance Scaling (RVS), or Latent scaling before synthesis (LSBS).
   In one example the processing might be skip mode.
   In one example the processing might comprise clamping the second sample according to a min and max values.
      The min and max values might be predefined,
      The min and max values might be derived based on an indication in the bitstream.

### Example Implementation of the Disclosure

The example below depicts a specific implementation of the disclosure. The constants (e.g. 10, or the value of b which is 7 or 12) are provided as example and different values for those constants are also possible.

According to an example, a bitstream is converted to a reconstructed image (or video) based on a masking and scaling operation, wherein:
A probability parameter sample is obtained using a first neural network.
Components of first value (a and b) are obtained from the bitstream.
Based on the first value and the probability parameter sample, a mask sample is obtained as follows:
   Summing probability parameter samples within a block of size 2ⁿ×2ⁿ, wherein n is a non-negative integer to obtain s (the sum value).
   A parameter K is obtained as K=10−b, wherein b might be 7 or 12, and the value of b is indicated in the bitstream.
   If K>0, mask samples is obtained according to:

$$( A << K ) > ( s >> 2 n ) , or ( A << K ) > ( ( s + {2}^{2 n - 1} >> 2 n )$$

If K<=0, mask samples is obtained according to:

$$A > ( s >> 2 n ) << K , or A > ( ( s + {2}^{2 n - 1} >> 2 n ) << K$$

The comparison operator (>) in the above example is not limited to (>) and other comparison operators are also possible.
Obtaining components of the second value as c and d.
Processing a second sample based on the value of the mask sample, c and d according to:
   Second sample*c>>d or,
   (Second sample*c+2^{d-1})>>d,
   If the value of the corresponding mask sample is equal to 1 and not processing the second sample if the value of the mask sample is equal to 0.
Reconstructed image is obtained according to processed second sample.

### 4.3 Benefits of the Examples

According to the disclosure, if the input of the mask and scale operation is integer valued, then the output is guaranteed to be integer valued. Moreover, the operations that are performed by the operation are:
Multiplication with integer,
Bit shifting operation,
Addition with an integer,
Integer division.

Therefore, no floating-point division, multiplication/addition with a non-integer value or rounding operation is necessary, which are operations that are device dependent (whose output might change when performed on different devices).

Mask and scale process that is presented in the present disclosure ensures that a neural subnetwork implemented with such process is device independent. In other words output of a subnetwork that is implemented using such process is guaranteed to provide identical output in any computing device. Therefore a bitstream that is encoded with one device (e.g. a computer) is decodable by another device (e.g. a mobile computing device), which is a fundamental requirement for image encoding/decoding.

### 5. EMBODIMENTS

### Decoder Example:

According to the disclosure, a bitstream is converted to a reconstructed image (or video) based on a masking and scaling operation, wherein:
A probability parameter sample is obtained using a first neural network.
A first value (e.g. a threshold) is obtained from a bitstream.
based on the first value and the probability parameter sample, obtaining a mask sample.
Processing a second sample based on the value of the mask sample.
Reconstructed image is obtained according to processed second sample.

Wherein the obtaining of the mask and processing of the second sample are implemented using integer operations.

More details of the embodiments of the present disclosure will be described below which are related to neural network-based visual data coding. As used herein, the term “visual data” may refer to a video, an image, a picture in a video, or any other visual data suitable to be coded.

As discussed above, in the existing design for neural network (NN)-based visual data coding, several operations (such as, multiplication with floating point number, division operation, addition with a floating point number, rounding operation, etc.) are used in the coding process while they are not well defined, and hence the result of these operations may be different from device to device. In other words, the result of these operations may be device-dependent. As a result, the NN-based visual data coding process is susceptible to coding errors. For example, a bitstream encoded in one device might not be decodable in another device.

To solve the above problems and some other problems not mentioned, visual data processing solutions as described below are disclosed. The embodiments of the present disclosure should be considered as examples to explain the general concepts and should not be interpreted in a narrow way. Furthermore, these embodiments can be applied individually or combined in any manner.

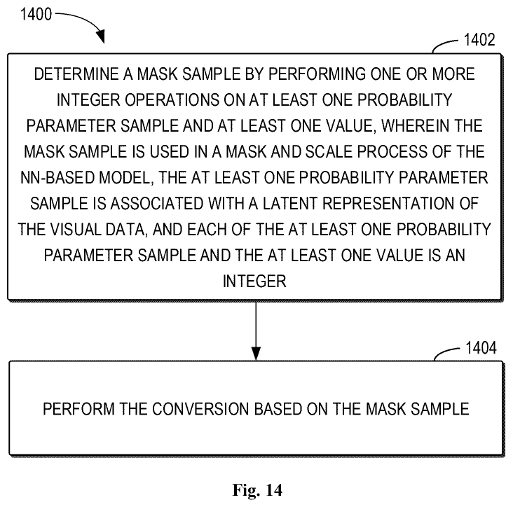

FIG. 14 illustrates a flowchart of a method 1400 for visual data processing in accordance with some embodiments of the present disclosure. The method 1400 may be implemented during a conversion between the visual data and a bitstream of the visual data, which is performed with a neural network (NN)-based model. As used herein, an NN-based model may be a model based on neural network technologies. For example, an NN-based model may specify sequence of neural network modules (also called architecture) and model parameters. The neural network module may comprise a set of neural network layers. Each neural network layer specifies a tensor operation which receives and outputs tensor, and each layer has trainable parameters. It should be understood that the possible implementations of the NN-based model described here are merely illustrative and therefore should not be construed as limiting the present disclosure in any way.

As shown in FIG. 14, the method 1400 starts at 1402, where a mask sample is determined by performing one or more integer operations on at least one probability parameter sample and at least one value. The mask sample is used in a mask and scale process of the NN-based model. In some embodiments, the mask and scale process may be common for several coding tools, such as residual and variance scale (RVS), skip mode (Skip) and latent scale before synthesis (LSBS), and/or the like.

The at least one probability parameter sample is associated with a latent representation of the visual data. For example, each of the at least one probability parameter sample may be an element of a 3-dimensional tensor or a 3-dimensional matrix, whose dimensions may be C×H×W, wherein C, H and W are positive integers. In one example, the probability parameter sample may be a sigma sample. In another example, the probability parameter sample may be a variance sample, such as a gaussian variance sample. In a further example, the probability parameter sample may be a standard deviation sample. It should be understood that the probability parameter sample may be a sample of any other suitable probability parameter, such as a mean value, and/or the like. In some embodiments, the probability parameter sample may be in a logarithm domain (a log domain for short).

In some embodiments, a probability parameter sample may be obtained from the bitstream based on at least one module of the NN-based model. For example, the at least one module may comprise a hyper scale decoder. By way of example, with reference to FIG. 13, a part of bitstream (denoted as BITS2) may be processed by arithmetic decoding process to obtain a quantized hyper latent representation (denoted as \hat{z}) at the decoder-side. Furthermore, the quantized hyper latent representation \hat{z} may be processed by a hyper scale decoder to obtain the probability parameter sample. It should be understood that the at least one module may also comprise any other suitable module, and the probability parameter sample may also be obtained in any other suitable manner. The scope of the present disclosure is not limited in this respect.

In some embodiments, the at least one probability parameter sample may be used in an entropy coding process (such as an arithmetic coding, a range coding, or like) of the NN-based model. For example, the at least one probability parameter sample may be used to determine the latent representation of the visual data. By way of example rather than limitation, the entropy coding process of samples of the latent representation may be performed based on the at least one probability parameter sample.

Furthermore, each of the at least one probability parameter sample and the at least one value is an integer. For example, each of the at least one probability parameter sample and the at least one value may be of an integer format. By way of example rather than limitation, the at least one value may be used as a scaling factor(s), an offset(s), a threshold(s), or the like. This will be described in detail below.

As used herein, if a result of an operation is an integer in case that all operands of the operation are integers, such an operation may be referred to as an integer operation. By way of example, a division operation is not an integer operation, since even when all operands of the division operation are integers, the result of the division operation may be a non-integer, such as 4/5=0.8. On the contrary, an addition operation is an integer operation, since if all operands of the addition operation are integers, the result of the addition operation is always an integer. Similarly, a summation operation, a subtraction operation, a multiplication operation, an integer division operation, a bit shifting operation, a clamping operation, a clipping operation, a comparison operation, a ternary conditional operation and the like are integer operations. A ternary conditional operation (a? b: c) is defined as follows: if condition a is true, then the result of the ternary conditional operation is equal to b; otherwise the result of ternary conditional operation is equal to c. It should be understood that the integer operation may also be a function, such as a rectified linear unit (ReLu) function shown in FIG. 12, and/or the like. The scope of the present disclosure is not limited in this respect.

It should be noted that, if any of operands of an integer operation is a non-integer, the result of the integer operation may be a non-integer. For example, if one of the operands of an integer operation is a floating point number, the result of the integer operation may be a floating point number, such as 10+1.2=11.2.

By way of example rather than limitation, the one or more integer operations may comprise a comparison operation. In such a case, the mask sample may be determined based on a result of performing the comparison operation on the at least one probability parameter sample and the at least one value. In some embodiments, a result of the comparison operation may be a first integer value or a second integer value dependent on whether operands of the comparison operation met a condition of the comparison operation. In one example, the first integer value and/or a second integer value may be predetermined, such as 0, 1, or the like. In another example, the first integer value or the second integer value may be equal to one of the operands of the comparison operation. In such a case, the ReLu function may also be regard as a kind of comparison operation.

By way of example rather than limitation, the at least one probability parameter sample may comprise a single probability parameter sample, and the at least one value may comprise a single threshold value, such as 32, 382, 512, or the like. If the single probability parameter sample is larger than the single threshold value, the mask sample may be determined to be a first integer value, such as 1 or the like. If the single probability parameter sample is smaller than or equal to the single threshold value, the mask sample may be determined to be a second integer value, such as 0 or the like. It should be understood that the above examples are described merely for purpose of description. The scope of the present disclosure is not limited in this respect.

Based on the above discussion, since each of the at least one probability parameter sample and the at least one value is an integer, it is ensured that all operands of the one or more integer operations that are performed on the at least one probability parameter sample and the at least one value are integers.

Thereby, the mask sample, as a result of performing the one or more integer operations, is ensured to be an integer.

At 1404, the conversion is performed based on the mask sample. By way of example, one or more samples associated the latent represent of the visual date may be scaled based on the mask sample. In some embodiments, the conversion may include encoding the visual data into the bitstream. Additionally or alternatively, the conversion may include decoding the visual data from the bitstream. It should be understood that the above illustrations are described merely for purpose of description. The scope of the present disclosure is not limited in this respect.

In view of the above, the mask sample used in the mask and scale process is obtained based on integer values and one or more integer operations. Thereby, the mask sample itself is ensured to be an integer, and thus it is device independent. Compared with the conventional solution where a floating point number(s) is involved in the determination of the mask sample, the proposed method is advantageously insusceptible to coding errors at this module, and thus the coding quality can be improved.

In some embodiments, at 1404, one or more samples associated with the latent representation of the visual data may be adjusted based on the mask. Moreover, the conversion is performed based on the adjusted one or more samples. In one example, the one or more samples associated with the latent representation may comprise one or more residual samples of the latent representation. In another example, the one or more samples associated with the latent representation may comprise one or more reconstructed residual samples of the latent representation. In a further example, the one or more samples associated with the latent representation may comprise one or more probability parameter samples for determining the latent representation, such as variance samples, sigma samples or the like. In a still further example, the one or more samples associated with the latent representation may comprise one or more prediction samples of the latent representation. It should be understood that the one or more samples associated with the latent representation may comprise any other suitable samples, such as one or more samples of the latent representation, or the like. The scope of the present disclosure is not limited in this respect.

In some embodiments, if the one or more samples are integers, the adjusted one or more samples are integers. For example, the one or more samples may be adjusted by only performing integer operation(s), such as a comparison operation, a multiplication operation, and/or the like. In this case, since the mask sample is ensured to be an integer and the one or more samples are integers, the adjusted one or more samples are also integers. Thereby, the mask and scale process can advantageously also be insusceptible to coding errors at this module, and thus the coding quality can be further improved.

In some embodiments, the at least one probability parameter sample may be clamped based on a first upper limit and/or a first lower limit, e.g., by using a clamping operation or a clipping operation. Each of the first upper limit and the first lower limit may be an integer. In one example, the first upper limit and/or the first lower limit may be predetermined. Alternatively, the first upper limit and/or the first lower limit may be indicated in the bitstream or determined based on information indicated in the bitstream. The scope of the present disclosure is not limited in this respect. A clipping operation may be defined as follows:

$$clip ( x , y , z ) = \{ \begin{matrix}x & ; & z \leq x \\ y & ; & z \geq y \\ z & ; & otherwise\end{matrix}$$

where x represents a lower limit, y represents an upper limit, and z represents a value to be clipped. It should be understood that either the lower limit or the upper limit may be omitted in practice. Thereby, the value of the at least one probability parameter sample may be limited to a desired range, so as to avoid unexpected errors, and thus the coding quality can be ensured.

In one example embodiment, the one or more samples associated with the latent representation of the visual data may be adjusted based on the mask sample in a skip mode process. By way of example rather than limitation, if the value of the mask sample is equal to 0, the value of a residual sample of the latent representation is inferred to be equal to zero. If the value of the mask sample is equal to 1, the value of the residual sample is obtained from the bitstream.

In some embodiments, the adjusted one or more samples may be clamped based on a second upper limit and/or a second lower limit, e.g., by using a clamping operation or a clipping operation. Each of the second upper limit and the second lower limit may be an integer. In one example, the second upper limit and/or the second lower limit may be predetermined. Alternatively, the second upper limit and/or the second lower limit may be indicated in the bitstream or determined based on information indicated in the bitstream. The scope of the present disclosure is not limited in this respect. Thereby, the value of the adjusted one or more samples may be limited to a desired range, so as to avoid unexpected errors, and thus the coding quality can be ensured.

In some further embodiments, the one or more integer operations may comprise at least one of the following: an addition operation, a subtraction operation, a summation operation, a multiplication operation, a clamping operation, a comparison operation, a bit shifting operation, a ternary conditional operation, or a rectified linear unit (Relu) function. It should be understood that the one or more integer operations may comprise any other suitable integer operation(s), such as a bitwise operation (e.g., bitwise AND, bitwise OR,) and/or the like. Moreover, the one or more integer operations may be any suitable combination of these integer operations.

By way of example rather than limitation, the at least one probability parameter sample may comprise a plurality of probability parameter samples. In this case, a summation operation (which may be denoted as Σ( )) may be performed on a part of the plurality of probability parameter samples that is within a block of a first size. For example, the first size may be N×N, and N may be a non-negative integer, such as 2, 4, 8, or the like. Furthermore, the mask sample may be determined based on the at least one value and a result of the summation operation.

In some example embodiments, the at least one value may comprise a first value, and the mask sample may be determined based on a result of one of the following comparison operations:

$$F < s ,$$

$$F \leq s ,$$

$$F > s , or$$

$$F \geq s ,$$

where F represents the first value, and s represents a result of the summation operation.

In some alternative embodiments, the mask sample may be determined based on a result of one of the following comparison operations:

$$F < ( s >> 2 n ) ,$$

$$F \leq ( s >> 2 n ) ,$$

$$F > ( s >> 2 n ) ,$$

$$F \geq ( s >> 2 n ) ,$$

$$F < ( ( s + 2 n - 1 ) >> 2 n ) ,$$

$$F \leq ( ( s + 2 n - 1 ) >> 2 n ) ,$$

$$F > ( ( s + 2 n - 1 ) >> 2 n ) ,$$

$$F \geq ( ( s + 2 n - 1 ) >> 2 n ) ,$$

$$F < ( s // {n}^{2} ) ,$$

$$F \leq ( s // {n}^{2} ) ,$$

$$F > ( s // {n}^{2} ) ,$$

$$F \geq ( s // {n}^{2} ) ,$$

$$F < ( ( s + {n}^{2} // 2 ) // {n}^{2} ) ,$$

$$F \leq ( ( s + {n}^{2} // 2 ) // {n}^{2} ) ,$$

$$F > ( ( s + {n}^{2} // 2 ) // {n}^{2} ) , or$$

$$F \geq ( ( s + {n}^{2} // 2 ) // {n}^{2} ) ,$$

where F represents the first value, s represents a result of the summation operation, and n represents a non-negative integer. In one example, n may be indicated in the bitstream. Alternatively, n may be fixed to a predetermined value, such as 2, 4, 8 or the like. It should be understood that the above example operations are described merely for purpose of description. More examples are illustrated in the above section 4.2. The scope of the present disclosure is not limited in this respect.

In some embodiments, the one or more samples associated with the latent representation of the visual data may be adjusted based on the mask sample in a residual and variance scale (RVS) process or a latent scaling before synthesis (LSBS) process. By way of example, the one or more samples may be adjusted by multiplying the one or more samples and a scaling factor based on the mask sample. By way of example rather than limitation, a product of the scaling factor and the value of the mask sample may be used to scale the one or more samples.

In some example embodiments, a first sample in the one or more samples may be adjusted according to:

$${R}^{′} = ( R * A + {2}^{B - 1} ) >> B ,$$

where R′ represents the adjusted first sample, R represents the first sample, and each of A and B may be an integer. For example, A may be determined based on the mask sample. In one example, A may be determined to be a product of the scaling factor and the value of the mask sample.

In some alternative embodiments, the first sample in the one or more samples may be adjusted according to one of the following:

$${R}^{′} = R * A / B ,$$

$${R}^{′} = R * A // B ,$$

$${R}^{′} = ( R * A + B // 2 ) // B ,$$

$${R}^{′} = R * A >> B ,$$

$${R}^{′} = R * A << B ,$$

$${R}^{′} = R << B // A ,$$

$${R}^{′} = R * A << B , or$$

$${R}^{′} = ( R << B + A // 2 ) // A ,$$

where R′ represents the adjusted first sample, R represents the first sample, each of A and B may be an integer, and//represents an integer division operation. It should be understood that the above example operations are described merely for purpose of description. More examples are illustrated in the above section 4.2. The scope of the present disclosure is not limited in this respect.

In some embodiments, one or more of the at least one value may be indicated in the bitstream. Additionally or alternatively, one or more of the at least one value may be determined based on information indicated in the bitstream. In some further embodiments, one or more of the at least one value may be predetermined. In this case, this/these value(s) may be not indicated in the bitstream. In some alternative or additional embodiments, one or more of the at least one value may be determined based on a formula. Additionally or alternatively, one or more of the at least one value may be determined based on or a lookup table.

Furthermore, the at least one value may be determined based on any suitable combination of the above-mentioned mechanisms. By way of example rather than limitation, a first parameter may be signaled in the bitstream. One of the at least one value may be obtained by retrieving a value in a look-up table that corresponds to the value of the first parameter. It should be understood that the at least one value may be determined in any other suitable manner.

In view of the above, the solutions in accordance with some embodiments of the present disclosure can advantageously implement the determination of the mask sample and/or the mask and scale process in a device independent manner. Thereby, the potential coding errors can be avoided and thus the coding quality can be improved.

According to further embodiments of the present disclosure, a non-transitory computer-readable recording medium is provided. The non-transitory computer-readable recording medium stores a bitstream of visual data which is generated by a method performed by an apparatus for visual data processing. In the method, a mask sample is determined by performing one or more integer operations on at least one probability parameter sample and at least one value. The mask sample is used in a mask and scale process of an NN-based model. The at least one probability parameter sample is associated with a latent representation of the visual data. Each of the at least one probability parameter sample and the at least one value is an integer. Moreover, the bitstream is generated based on the mask sample with the NN-based model.

According to still further embodiments of the present disclosure, a method for storing bitstream of visual data is provided. In the method, a mask sample is determined by performing one or more integer operations on at least one probability parameter sample and at least one value. The mask sample is used in a mask and scale process of an NN-based model. The at least one probability parameter sample is associated with a latent representation of the visual data. Each of the at least one probability parameter sample and the at least one value is an integer. Moreover, the bitstream is generated based on the mask sample with the NN-based model, and stored in a non-transitory computer-readable recording medium.

Implementations of the present disclosure can be described in view of the following clauses, the features of which can be combined in any reasonable manner.

Clause 1. A method for visual data processing, comprising: determining, for a conversion between visual data and a bitstream of the visual data with a neural network (NN)-based model, a mask sample by performing one or more integer operations on at least one probability parameter sample and at least one value, wherein the mask sample is used in a mask and scale process of the NN-based model, the at least one probability parameter sample is associated with a latent representation of the visual data, and each of the at least one probability parameter sample and the at least one value is an integer; and performing the conversion based on the mask sample.

Clause 2. The method of clause 1, wherein performing the conversion based on the mask sample comprises: adjusting, based on the mask sample, one or more samples associated with the latent representation of the visual data; and performing the conversion based on the adjusted one or more samples.

Clause 3. The method of clause 2, wherein if the one or more samples are integers, the adjusted one or more samples are integers.

Clause 4. The method of any of clauses 1-3, wherein for each of the one or more integer operations, if all operands of the integer operation are integers, a result of the integer operation is an integer.

Clause 5. The method of any of clauses 1-4, wherein all operands of the one or more integer operations are integers.

Clause 6. The method of any of clauses 1-5, wherein the one or more integer operations comprise a comparison operation, and the mask sample is determined based on a result of performing the comparison operation on the at least one probability parameter sample and the at least one value.

Clause 7. The method of clause 6, wherein a result of the comparison operation is a first integer value or a second integer value dependent on whether operands of the comparison operation met a condition of the comparison operation.

Clause 8. The method of clause 7, wherein the first integer value or the second integer value is equal to one of the operands of the comparison operation.

Clause 9. The method of any of clauses 4-8, wherein one or more samples associated with the latent representation of the visual data are adjusted based on the mask sample in a skip mode process.

Clause 10. The method of any of clauses 1-5, wherein the one or more integer operations comprise at least one of the following: an addition operation, a subtraction operation, a summation operation, a multiplication operation, a clamping operation, a comparison operation, a bit shifting operation, a ternary conditional operation, or a rectified linear unit (Relu) function.

Clause 11. The method of clause 10, wherein the at least one probability parameter sample comprises a plurality of probability parameter samples, and a summation operation is performed on a part of the plurality of probability parameter samples that is within a block of a first size.

Clause 12. The method of clause 11, wherein the first size is N×N, and N is a non-negative integer.

Clause 13. The method of any of clauses 10-12, wherein the mask sample is determined based on the at least one value and a result of the summation operation.

Clause 14. The method of any of clauses 10-13, wherein one or more samples associated with the latent representation of the visual data are adjusted based on the mask sample in a residual and variance scale (RVS) process or a latent scaling before synthesis (LSBS) process.

Clause 15. The method of clause 2-14, wherein the one or more samples are adjusted by multiplying the one or more samples and a scaling factor based on the mask sample.

Clause 16. The method of any of clauses 1-15, wherein the at least one value comprises a single threshold value.

Clause 17. The method of any of clauses 1-16, wherein the at least one probability parameter sample comprises at least one of the following: a gaussian variance sample, or a sigma sample.

Clause 18. The method of any of clauses 1-17, wherein each of the at least one probability parameter sample is an element of a 3-dimensional tensor or a 3-dimensional matrix.

Clause 19. The method of any of any of clauses 1-18, wherein the at least one probability parameter sample is used in an entropy coding process of the NN-based model.

Clause 20. The method of any of clauses 2-19, wherein the one or more samples associated with the latent representation comprise one of the following: a residual sample of the latent representation, a reconstructed residual sample of the latent representation, a probability parameter sample for determining the latent representation, a prediction sample of the latent representation, or a sample of the latent representation.

Clause 21. The method of clause 20, wherein the probability parameter sample comprises at least one of the following: a variance sample, or a sigma sample.

Clause 22. The method of any of clauses 1-21, wherein one or more of the at least one value are indicated in the bitstream, or one or more of the at least one value are determined based on information indicated in the bitstream, or one or more of the at least one value are predetermined, or one or more of the at least one value are determined based on a formula, or one or more of the at least one value are determined based on or a lookup table.

Clause 23. The method of any of clauses 1-22, wherein the at least one probability parameter sample is clamped based on a first upper limit and a first lower limit, and each of the first upper limit and the first lower limit is an integer.

Clause 24. The method of any of clauses 1-23, wherein the at least one probability parameter sample is obtained from the bitstream based on at least one module of the NN-based model.

Clause 25. The method of clause 24, wherein the at least one module comprises a hyper scale decoder.

Clause 26. The method of any of clauses 2-25, wherein the adjusted one or more samples are clamped based on a second upper limit and a second lower limit, and each of the second upper limit and the second lower limit is an integer.

Clause 27. The method of any of clauses 2-26, wherein a first sample in the one or more samples is adjusted according to:

$${R}^{′} = ( R * A + {2}^{B - 1} ) >> B ,$$

where R′ represents the adjusted first sample, R represents the first sample, and each of A and B is an integer.

Clause 28. The method of any of clauses 2-26, wherein a first sample in the one or more samples is adjusted according to one of the following:

$${R}^{′} = R * A / B ,$$

$${R}^{′} = R * A // B ,$$

$${R}^{′} = ( R * A + B // 2 ) // B ,$$

$${R}^{′} = R * A >> B ,$$

$${R}^{′} = R * A << B ,$$

$${R}^{′} = R << B // A ,$$

$${R}^{′} = R * A << B , or$$

$${R}^{′} = ( R << B + A // 2 ) // A ,$$

where R′ represents the adjusted first sample, R represents the first sample, and each of A and B is an integer.

Clause 29. The method of clause 13, wherein the at least one value comprises a first value, and the mask sample is determined based on a result of one of the following comparison operations:

$$F < s ,$$

$$F \leq s ,$$

$$F > s , or$$

$$F \geq s ,$$

where F represents the first value, and s represents a result of the summation operation.

Clause 30. The method of clause 13, wherein the at least one value comprises a first value, and the mask sample is determined based on a result of one of the following comparison operations:

$$F < ( s >> 2 n ) ,$$

$$F \leq ( s >> 2 n ) ,$$

$$F > ( s >> 2 n ) ,$$

$$F \geq ( s >> 2 n ) ,$$

$$F < ( ( s + 2 n - 1 ) >> 2 n ) ,$$

$$F \leq ( ( s + 2 n - 1 ) >> 2 n ) ,$$

$$F > ( ( s + 2 n - 1 ) >> 2 n ) ,$$

$$F \geq ( ( s + 2 n - 1 ) >> 2 n ) ,$$

$$F < ( s // {n}^{2} ) ,$$

$$F \leq ( s // {n}^{2} ) ,$$

$$F > ( s // {n}^{2} ) ,$$

$$F \geq ( s // {n}^{2} ) ,$$

$$F < ( ( s + {n}^{2} // 2 ) // {n}^{2} ) ,$$

$$F \leq ( ( s + {n}^{2} // 2 ) // {n}^{2} ) ,$$

$$F > ( ( s + {n}^{2} // 2 ) // {n}^{2} ) , or$$

$$F \geq ( ( s + {n}^{2} // 2 ) // {n}^{2} ) ,$$

where F represents the first value, s represents a result of the summation operation, and n represents a non-negative integer.

Clause 31. The method of any of clauses 1-30, wherein the visual data comprise a video, a picture of the video, or an image.

Clause 32. The method of any of clauses 1-31, wherein the conversion includes encoding the visual data into the bitstream.

Clause 33. The method of any of clauses 1-31, wherein the conversion includes decoding the visual data from the bitstream.

Clause 34. An apparatus for visual data processing comprising a processor and a non-transitory memory with instructions thereon, wherein the instructions upon execution by the processor, cause the processor to perform a method in accordance with any of clauses 1-33.

Clause 35. A non-transitory computer-readable storage medium storing instructions that cause a processor to perform a method in accordance with any of clauses 1-33.

Clause 36. A non-transitory computer-readable recording medium storing a bitstream of visual data which is generated by a method performed by an apparatus for visual data processing, wherein the method comprises: determining a mask sample by performing one or more integer operations on at least one probability parameter sample and at least one value, wherein the mask sample is used in a mask and scale process of an NN-based model, the at least one probability parameter sample is associated with a latent representation of the visual data, and each of the at least one probability parameter sample and the at least one value is an integer; and generating the bitstream based on the mask sample with the NN-based model.

Clause 37. A method for storing a bitstream of visual data, comprising: determining a mask sample by performing one or more integer operations on at least one probability parameter sample and at least one value, wherein the mask sample is used in a mask and scale process of an NN-based model, the at least one probability parameter sample is associated with a latent representation of the visual data, and each of the at least one probability parameter sample and the at least one value is an integer; generating the bitstream based on the mask sample with the NN-based model; and storing the bitstream in a non-transitory computer-readable recording medium.

### Example Device

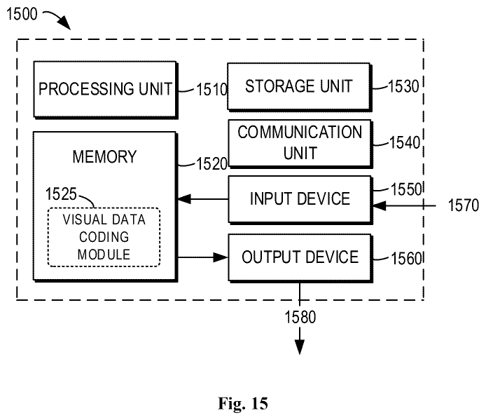

FIG. 15 illustrates a block diagram of a computing device 1500 in which various embodiments of the present disclosure can be implemented. The computing device 1500 may be implemented as or included in the source device 110 (or the visual data encoder 114) or the destination device 120 (or the visual data decoder 124).

It would be appreciated that the computing device 1500 shown in FIG. 15 is merely for purpose of illustration, without suggesting any limitation to the functions and scopes of the embodiments of the present disclosure in any manner.

As shown in FIG. 15, the computing device 1500 includes a general-purpose computing device 1500. The computing device 1500 may at least comprise one or more processors or processing units 1510, a memory 1520, a storage unit 1530, one or more communication units 1540, one or more input devices 1550, and one or more output devices 1560.

In some embodiments, the computing device 1500 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1500 can support any type of interface to a user (such as “wearable” circuitry and the like).

The processing unit 1510 may be a physical or virtual processor and can implement various processes based on programs stored in the memory 1520. In a multi-processor system, multiple processing units execute computer executable instructions in parallel so as to improve the parallel processing capability of the computing device 1500. The processing unit 1510 may also be referred to as a central processing unit (CPU), a microprocessor, a controller or a microcontroller.

The computing device 1500 typically includes various computer storage medium. Such medium can be any medium accessible by the computing device 1500, including, but not limited to, volatile and non-volatile medium, or detachable and non-detachable medium. The memory 1520 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1530 may be any detachable or non-detachable medium and may include a machine-readable medium such as a memory, flash memory drive, magnetic disk or another other media, which can be used for storing information and/or visual data and can be accessed in the computing device 1500.

The computing device 1500 may further include additional detachable/non-detachable, volatile/non-volatile memory medium. Although not shown in FIG. 15, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more visual data medium interfaces.

The communication unit 1540 communicates with a further computing device via the communication medium. In addition, the functions of the components in the computing device 1500 can be implemented by a single computing cluster or multiple computing machines that can communicate via communication connections. Therefore, the computing device 1500 can operate in a networked environment using a logical connection with one or more other servers, networked personal computers (PCs) or further general network nodes.

The input device 1550 may be one or more of a variety of input devices, such as a mouse, keyboard, tracking ball, voice-input device, and the like. The output device 1560 may be one or more of a variety of output devices, such as a display, loudspeaker, printer, and the like. By means of the communication unit 1540, the computing device 1500 can further communicate with one or more external devices (not shown) such as the storage devices and display device, with one or more devices enabling the user to interact with the computing device 1500, or any devices (such as a network card, a modem and the like) enabling the computing device 1500 to communicate with one or more other computing devices, if required. Such communication can be performed via input/output (I/O) interfaces (not shown).

In some embodiments, instead of being integrated in a single device, some or all components of the computing device 1500 may also be arranged in cloud computing architecture. In the cloud computing architecture, the components may be provided remotely and work together to implement the functionalities described in the present disclosure. In some embodiments, cloud computing provides computing, software, visual data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding visual data may be stored on a server at a remote position. The computing resources in the cloud computing environment may be merged or distributed at locations in a remote visual data center. Cloud computing infrastructures may provide the services through a shared visual data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1500 may be used to implement visual data encoding/decoding in embodiments of the present disclosure. The memory 1520 may include one or more visual data coding modules 1525 having one or more program instructions. These modules are accessible and executable by the processing unit 1510 to perform the functionalities of the various embodiments described herein.

In the example embodiments of performing visual data encoding, the input device 1550 may receive visual data as an input 1570 to be encoded. The visual data may be processed, for example, by the visual data coding module 1525, to generate an encoded bitstream. The encoded bitstream may be provided via the output device 1560 as an output 1580.

In the example embodiments of performing visual data decoding, the input device 1550 may receive an encoded bitstream as the input 1570. The encoded bitstream may be processed, for example, by the visual data coding module 1525, to generate decoded visual data. The decoded visual data may be provided via the output device 1560 as the output 1580.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for visual data processing, comprising:
determining, for a conversion between visual data and a bitstream of the visual data with a neural network (NN)-based model, a mask sample by performing one or more integer operations on at least one probability parameter sample and at least one value, wherein the mask sample is used in a mask and scale process of the NN-based model, the at least one probability parameter sample is associated with a latent representation of the visual data, and each of the at least one probability parameter sample and the at least one value is an integer; and
performing the conversion based on the mask sample.

2. The method of claim 1, wherein performing the conversion based on the mask sample comprises:
adjusting, based on the mask sample, one or more samples associated with the latent representation of the visual data; and
performing the conversion based on the adjusted one or more samples.

3. The method of claim 1, wherein for each of the one or more integer operations, if all operands of the integer operation are integers, a result of the integer operation is an integer, or
wherein all operands of the one or more integer operations are integers, or
wherein the one or more integer operations comprise a comparison operation, and the mask sample is determined based on a result of performing the comparison operation on the at least one probability parameter sample and the at least one value.

4. The method of claim 3, wherein a result of the comparison operation is a first integer value or a second integer value dependent on whether operands of the comparison operation met a condition of the comparison operation.

5. The method of claim 4, wherein the first integer value or the second integer value is equal to one of the operands of the comparison operation.

6. The method of claim 3, wherein one or more samples associated with the latent representation of the visual data are adjusted based on the mask sample in a skip mode process.

7. The method of claim 1, wherein the one or more integer operations comprise at least one of the following:
an addition operation,
a subtraction operation,
a summation operation,
a multiplication operation,
a clamping operation,
a comparison operation,
a bit shifting operation,
a ternary conditional operation, or
a rectified linear unit (Relu) function.

8. The method of claim 7, wherein the at least one probability parameter sample comprises a plurality of probability parameter samples, and a summation operation is performed on a part of the plurality of probability parameter samples that is within a block of a first size, or
wherein the mask sample is determined based on the at least one value and a result of the summation operation, or
wherein one or more samples associated with the latent representation of the visual data are adjusted based on the mask sample in a residual and variance scale (RVS) process or a latent scaling before synthesis (LSBS) process.

9. The method of claim 2, wherein the one or more samples are adjusted by multiplying the one or more samples and a scaling factor based on the mask sample.

10. The method of claim 1, wherein the at least one value comprises a single threshold value, or
wherein the at least one probability parameter sample comprises at least one of the following: a variance sample, or a sigma sample, or
wherein each of the at least one probability parameter sample is an element of a 3-dimensional tensor, or
wherein the at least one probability parameter sample is used in an entropy coding process of the NN-based model.

11. The method of claim 2, wherein the one or more samples associated with the latent representation comprise one of the following:
a residual sample of the latent representation,
a reconstructed residual sample of the latent representation,
a probability parameter sample for determining the latent representation,
a prediction sample of the latent representation, or
a sample of the latent representation.

12. The method of claim 1, wherein one or more of the at least one value are indicated in the bitstream, or
one or more of the at least one value are determined based on information indicated in the bitstream, or
one or more of the at least one value are predetermined, or
one or more of the at least one value are determined based on a formula, or
one or more of the at least one value are determined based on or a lookup table.

13. The method of claim 1, wherein the at least one probability parameter sample is clamped based on a first upper limit and a first lower limit, and each of the first upper limit and the first lower limit is an integer.

14. The method of claim 1, wherein the at least one probability parameter sample is obtained from the bitstream based on at least one module of the NN-based model.

15. The method of claim 14, wherein the at least one module comprises a hyper scale decoder.

16. The method of claim 2, wherein a first sample in the one or more samples is adjusted according to:
$${R}^{′} = ( R * A + {2}^{B - 1} ) >> B ,$$
where R′ represents the adjusted first sample, R represents the first sample, and each of A and B is an integer.

17. The method of claim 1, wherein the visual data comprise a video, a picture of the video, or an image, or
wherein the conversion includes encoding the visual data into the bitstream, or
wherein the conversion includes decoding the visual data from the bitstream.

18. An apparatus for visual data processing comprising a processor and a non-transitory memory with instructions thereon, wherein the instructions upon execution by the processor, cause the processor to perform acts comprising:
determining, for a conversion between visual data and a bitstream of the visual data with a neural network (NN)-based model, a mask sample by performing one or more integer operations on at least one probability parameter sample and at least one value, wherein the mask sample is used in a mask and scale process of the NN-based model, the at least one probability parameter sample is associated with a latent representation of the visual data, and each of the at least one probability parameter sample and the at least one value is an integer; and
performing the conversion based on the mask sample.

19. A non-transitory computer-readable storage medium storing instructions that cause a processor to perform acts comprising:
determining, for a conversion between visual data and a bitstream of the visual data with a neural network (NN)-based model, a mask sample by performing one or more integer operations on at least one probability parameter sample and at least one value, wherein the mask sample is used in a mask and scale process of the NN-based model, the at least one probability parameter sample is associated with a latent representation of the visual data, and each of the at least one probability parameter sample and the at least one value is an integer; and
performing the conversion based on the mask sample.

20. A non-transitory computer-readable recording medium storing a bitstream of visual data which is generated by a method performed by an apparatus for visual data processing, wherein the method comprises:
determining a mask sample by performing one or more integer operations on at least one probability parameter sample and at least one value, wherein the mask sample is used in a mask and scale process of an NN-based model, the at least one probability parameter sample is associated with a latent representation of the visual data, and each of the at least one probability parameter sample and the at least one value is an integer; and
generating the bitstream based on the mask sample with the NN-based model.
